(19) United States
(12) Patent Application Publication
(10) Pub. No.: US 2003/0223468 A1
(43) Pub. Date: Dec. 4, 2003

(54) Service providing system, information processing apparatus and method, recording medium, and program

(76) Inventor: Tadaharu Koga, Tokyo (JP)

Correspondence Address: William S. Frommer, Esq., FROMMER LAWRENCE & HAUG LLP, 745 FIFTH AVENUE, NEW YORK, NY, 10151, US

(21) Appl. No.: 10/411,709

(22) Filed: Apr. 11, 2003

(30) Foreign Application Priority Data
Apr. 12, 2002 (JP) 2002-110046

(51) Int. Cl. H04J 3/02

(52) U.S. Cl. 370/537; 370/486

(57) ABSTRACT

The present invention is intended to make the correction of video data taken by an imaging apparatus in accordance with its characteristics. A camera VTR server records an device ID for device identification to an omnidirectional camera manufactured by a camera VTR maker and then stores the device ID stored in the omnidirectional camera and meta data for video data correction unique to each model of the omnidirectional camera into a hardware data center server (HDC server). A broadcasting data server gets the meta data corresponding to the device ID of the omnidirectional camera owned by a broadcasting station from the HDC server. A transmitting apparatus multiplexes the video data taken by the omnidirectional camera and recorded to a VTR with the meta data owned by the broadcasting station server and broadcasts the multiplexed video data. A set-top box (STB) corrects the video data contained in the received broadcast by the multiplexed meta data and displays the corrected video data on a television receiver.

### BACKGROUND OF THE INVENTTON

The present invention relates generally to a service providing system, an information processing apparatus and method, a recording medium, and a program and, more particularly, to a service providing system, an information processing apparatus and method, a recording medium, and a program which reproduce video with higher fidelity than that provided by related-art technologies.

In carrying out authoring of video data and audio data at a conventional broadcasting station, editors who perform authoring must grasp the characteristics of the professional-use equipment such as cameras by means of their experience or by learning from other experienced editors for example, thereby performing editing jobs in accordance with equipment characteristics thus obtained.

However, in understanding the equipment characteristics by the conventional methods as described above, each editor has to be well experienced in equipment handling or have people around him who are well experienced in equipment handling, which present problems of making it difficult for each editor to get the equipment characteristics with ease.

In addition, the equipment characteristics based on own experience and the knowledge from other people do not always provide correct information.

Moreover, it has not been practiced so far to correct the captured video for example by the correct characteristics data of each equipment such as a camera.

### SUMMARY OF THE INVENTION

It is therefore an object of the present invention to provide the reproduction of video with higher fidelity.

It is therefore an object of the present invention to provide the reproduction of video with fidelity.

According to the first aspect of the present invention, there is provided a service providing system configured by a first information processing apparatus for managing correction information unique to each model of imaging apparatus for correcting video data taken by the imaging apparatus, a second information processing apparatus for multiplexing the correction information with the video data and broadcasting the multiplexed video data as a broadcast, and a third information processing apparatus for receiving the broadcast,

the first information processing apparatus including:

storage means for storing the correction information; and

transmitting means for transmitting the correction information from the storage means to the second information processing apparatus,

the second information processing apparatus including:

first receiving means for receiving the correction information from the first information processing apparatus; and

broadcasting means for multiplexing the correction information with the video data captured by the imaging apparatus and broadcasting the multiplexed video data, and

the third information processing apparatus including:

second receiving means for receiving the multiplexed video data broadcast by the second information processing apparatus; and

correcting means for correcting the video data by the correction information multiplexed with the video data received by the second receiving means.

According to the second aspect of the present invention, there is provided an information processing apparatus including:

storage means for storing correction information unique to each model of imaging apparatus for correcting video data captured by the imaging apparatus; and

transmitting means for transmitting the correction information from the storage means to first another information processing apparatus.

According to the third aspect of the present invention, there is provided an information processing method including the steps of:

storing correction information unique to each model of imaging apparatus for correcting video data taken by the imaging apparatus; and

transmitting the correction information stored by the storage step to another information processing apparatus.

According to the fourth aspect of the present invention, there is provided a recording medium storing a computer-readable program including the steps of:

storage control for controlling storage of correction information unique to each model of imaging apparatus for correcting video data taken by the imaging apparatus; and

transmission control for controlling transmission of the correction information stored by the storage control step to another information processing apparatus.

According to the fifth aspect of the present invention, there is provided a program for causing a computer to execute the steps of:

storage control for controlling storage of correction information unique to each model of imaging apparatus for correcting video data taken by the imaging apparatus; and

transmission control for controlling transmission of the correction information stored by the storage control step to another information processing apparatus.

According to the sixth aspect of the present invention, there is provided an information processing apparatus including:

receiving means for receiving correction information unique to each model of imaging apparatus for correcting video data taken by the imaging apparatus from a first another information apparatus; and

broadcasting means for multiplexing the video data taken by the imaging apparatus with the correction information for broadcasting.

According to the seventh aspect of the present invention, there is provided an information processing method including the steps of:

receiving correction information unique to each model of imaging apparatus for correcting video data taken by the imaging apparatus from another information apparatus; and

multiplexing the video data taken by the imaging apparatus with the correction information for broadcasting.

According to the eighth aspect of the present invention, there is provided a recording medium storing a computer-readable program including the steps of:

reception control for receiving correction information unique to each model of imaging apparatus for correcting video data taken by the imaging apparatus from another information apparatus; and

broadcasting control for multiplexing the video data taken by the imaging apparatus with the correction information for broadcasting.

According to the ninth aspect of the present invention, there is provided a program for causing a computer to execute the steps of:

reception control for receiving correction information unique to each model of imaging apparatus for correcting video data taken by the imaging apparatus from another information apparatus; and

broadcasting control for multiplexing the video data taken by the imaging apparatus with the correction information for broadcasting.

According to the tenth aspect of the present invention, there is provided an information processing apparatus for receiving a broadcast in which correction information unique to each model of imaging apparatus for correcting video data taken by the imaging apparatus is multiplexed with the video data, including:

receiving means for receiving the video data broadcast by a first another information processing apparatus; and

correcting means for correcting the video data by the correction information multiplexed with the video data received by the receiving means.

According to the eleventh aspect of the present invention, there is provided an information processing method for an information processing apparatus for receiving a broadcast in which correction information unique to each model of imaging apparatus for correcting video data taken by the imaging apparatus is multiplexed with the video data, including the steps of:

receiving the video data broadcast by another information processing apparatus; and

correcting the video data by the correction information multiplexed with the video data received by the receiving step.

According to the twelfth aspect of the present invention, there is provided a recording medium storing a computer-readable program for an information processing apparatus for receiving a broadcast in which correction information unique to each model of imaging apparatus for correcting video data taken by the imaging apparatus is multiplexed with the video data, including the steps of:

reception control for receiving the video data broadcast by another information processing apparatus; and

correction control for correcting the video data by the correction information multiplexed with the video data received by the reception control step.

According to the thirteenth aspect of the present invention, there is provided a program for causing a computer for controlling an information processing apparatus for receiving a broadcast in which correction information unique to each model of imaging apparatus for correcting video data taken by the imaging apparatus is multiplexed with the video data to execute the steps of:

reception control for receiving the video data broadcast by another information processing apparatus; and

correction control for correcting the video data by the correction information multiplexed with the video data received by the reception control step.

According to the fourteenth aspect of the present invention, there is provided a service providing system configured by a first information processing apparatus for managing correction information unique to each model of imaging apparatus for correcting video data taken by the imaging apparatus, a second information processing apparatus multiplexing identification information for identifying the imaging apparatus with the video data and broadcasting the multiplexed video data as a broadcast, and a third information processing apparatus for receiving the broadcast,

the first information processing apparatus including:

storage means for storing the correction information as related with the identification information;

first receiving means for receiving a request for the transmission of the correction information corresponding to the identification information from the third information processing apparatus; and

transmitting means for transmitting the correction information stored by the storage means as related with the identification information to the third information processing apparatus if the request is received by the first receiving means,

the second information processing apparatus including:

broadcasting means for multiplexing the identification information with the video data taken by the imaging apparatus for broadcasting, and

the third information processing apparatus including:

second receiving means for receiving the video data broadcast by the second information processing apparatus;

reading means for reading the identification information multiplexed with the video data received by the second receiving means;

requesting means for requesting the first information processing apparatus for the correction information corresponding to the identification information read by the reading means;

third receiving means for receiving the correction information from the first information processing apparatus; and

correcting means for correcting the video data by the correction information received by the third receiving means.

According to the fifteenth aspect of the present invention, there is provided an information processing apparatus including:

storage means for storing correction information unique to each model of imaging apparatus for correcting video data taken by the imaging apparatus, as related with identification information for identifying the imaging apparatus;

receiving means for receiving a request from another information processing apparatus for the transmission of the correction information corresponding to the identification information; and

transmitting means for transmitting the correction information stored by the storage means as related with the identification information to the another information processing apparatus if the request is received by the receiving means.

According to the sixteenth aspect of the present invention, there is provided an information processing method including the steps of:

storing correction information unique to each model of imaging apparatus for correcting video data taken by the imaging apparatus, as related with identification information for identifying the imaging apparatus;

receiving a request from another information processing apparatus for the transmission of the correction information corresponding to the identification information; and

transmitting the correction information stored by the storage step as related with the identification information to the another information processing apparatus if the request is received by the receiving step.

According to the seventeenth aspect of the present invention, there is provided a recording medium storing a computer-readable program including the steps of:

storage control for storing correction information unique to each model of imaging apparatus for correcting video data taken by the imaging apparatus, as related with identification information for identifying the imaging apparatus;

reception control for receiving a request from another information processing apparatus for the transmission of the correction information corresponding to the identification information; and

transmission control for transmitting the correction information stored by the storage control step as related with the identification information to the another information processing apparatus if the request is received by the reception control step.

According to the eighteenth aspect of the present invention, there is provided a program for causing a computer to execute the steps of:

storage control for storing correction information unique to each model of imaging apparatus for correcting video data taken by the imaging apparatus, as related with identification information for identifying the imaging apparatus;

reception control for receiving a request from another information processing apparatus for the transmission of the correction information corresponding to the identification information; and

transmission control for transmitting the correction information stored by the storage control step as related with the identification information to the another information processing apparatus if the request is received by the reception control step.

According to the nineteenth aspect of the present invention, there is provided an information processing apparatus including:

broadcasting means for multiplexing video data taken by an imaging apparatus with identification information for identifying the imaging apparatus and broadcasting the resultant video data.

According to the twentieth aspect of the present invention, there is provided an information processing method including the step of:

multiplexing video data taken by an imaging apparatus with identification information for identifying the imaging apparatus and broadcasting the resultant video data.

According to the twenty-first aspect of the present invention, there is provided a recording medium storing a computer-readable program including the step of:

multiplexing video data taken by an imaging apparatus with identification information for identifying the imaging apparatus and broadcasting the resultant video data.

According to the twenty-second aspect of the present invention, there is provided a program for causing a computer to execute the step of:

multiplexing video data taken by an imaging apparatus with identification information for identifying the imaging apparatus and broadcasting the resultant video data.

According to the twenty-third aspect of the present invention, there is provided an information processing apparatus including:

first receiving means for receiving video data broadcast by a first another information processing apparatus;

reading means for reading identification information for identifying an imaging apparatus multiplexed with the video data received by the first receiving means;

requesting means for requesting a second another information processing apparatus for correction information corresponding to the identification information read by the reading means for correcting the video data;

second receiving means for receiving the correction information from the second information processing apparatus; and

correcting means for correcting the video data by the correction information received by the second receiving means.

According to the twenty-fourth aspect of the present invention, there is provided an information processing method including the steps of:

receiving video data broadcast by a first another information processing apparatus;

reading identification information for identifying an imaging apparatus multiplexed with the video data received by the first receiving step;

requesting a second another information processing apparatus for correction information corresponding to the identification information read by the reading step for correcting the video data;

receiving the correction information from the second another information processing apparatus; and

correcting the video data by the correction information received by the second receiving step.

According to the twenty-fifth aspect of the present invention, there is provided a recording medium storing a computer-readable program including the steps of:

reception control for receiving video data broadcast by a first another information processing apparatus;

read control for reading identification information for identifying an imaging apparatus multiplexed with the video data received by the first reception control step;

request control for requesting a second another information processing apparatus for correction information corresponding to the identification information read by the read control step for correcting the video data;

reception control for receiving the correction information from the second information processing apparatus; and

correction control for correcting the video data by the correction information received by the second reception control step.

According to the twenty-sixth aspect of the present invention, there is provided a program for causing a computer to execute the steps of:

reception control for receiving video data broadcast by a first another information processing apparatus;

read control for reading identification information for identifying an imaging apparatus multiplexed with the video data received by the first reception control step;

request control for requesting a second another information processing apparatus for correction information corresponding to the identification information read by the read control step for correcting the video data;

reception control for receiving the correction information from the second another information processing apparatus; and

correction control for correcting the video data by the correction information received by the second reception control step.

According to the twenty-seventh aspect of the present invention, there is provided a service providing system configured by a first information processing apparatus for managing correction information unique to each model of imaging apparatus for correcting video data taken by the imaging apparatus, a second information processing apparatus for taking video data with the imaging apparatus to create content, and a third information processing apparatus for correcting the video data taken by the imaging apparatus,

the first information processing apparatus including:

recording means for recording identification information for identifying the imaging apparatus to the imaging apparatus;

storage means for storing the correction information as related with the identification information;

first receiving means for receiving a request for the transmission of the correction information corresponding to the identification information from the third information processing apparatus; and

first transmitting means for transmitting the correction information stored by the storage means as related with the identification information to the third information processing apparatus if the request is received by the first receiving means,

the second information processing apparatus including:

first requesting means for transmitting the video data taken by the imaging apparatus and the identification information to the third information processing apparatus to request for the correction of the video data; and

second receiving means for receiving the corrected video data from the third information processing apparatus, and

the third information processing apparatus including:

third receiving means for receiving the video data, the identification information, and the request for the correction of the video data from the second information processing apparatus;

second requesting means for requesting the first information processing apparatus for the correction information corresponding to the identification information received by the third receiving means;

fourth receiving means for receiving the correction information from the first information processing apparatus;

correcting means for correcting the video data by the correction information received by the fourth receiving means; and

second transmitting means for transmitting the video data corrected by the correcting means to second information processing apparatus.

According to the twenty-eighth aspect of the present invention, there is provided an information processing apparatus including:

recording means for recording identification information for identifying an imaging apparatus to the imaging apparatus;

storage means for storing correction information unique to each model of the imaging apparatus for correcting video data taken by the imaging apparatus as related with the identification information;

receiving means for receiving from another information processing apparatus a request for the transmission of the correction information corresponding to the identification information; and

transmitting means for transmitting the correction information stored by the storage means as related with the identification information to the another information processing apparatus if the request is received by the receiving means.

According to the twenty-ninth aspect of the present invention, there is provided an information processing method including the steps of:

recording identification information for identifying an imaging apparatus to the imaging apparatus;

storing correction information unique to each model of the imaging apparatus for correcting video data taken by the imaging apparatus as related with the identification information;

receiving from another information processing apparatus a request for the transmission of the correction information corresponding to the identification information; and

transmitting the correction information stored by the storage step as related with the identification information to the another information processing apparatus if the request is received by the receiving step.

According to the thirtieth aspect of the present invention, there is provided a recording medium storing a computer-readable program including the steps of:

recording control for recording identification information for identifying an imaging apparatus to the imaging apparatus;

storage control for storing correction information unique to each model of the imaging apparatus for correcting video data taken by the imaging apparatus as related with the identification information;

reception control for receiving from another information processing apparatus a request for the transmission of the correction information corresponding to the identification information; and

transmission control for transmitting the correction information stored by the storage control step as related with the identification information to the another information processing apparatus if the request is received by the reception control step.

According to the thirty-first aspect of the present invention, there is provided a program for causing a computer to execute the steps of:

recording control for recording identification information for identifying an imaging apparatus to the imaging apparatus;

storage control for storing correction information unique to each model of the imaging apparatus for correcting video data taken by the imaging apparatus as related with the identification information;

reception control for receiving from another information processing apparatus a request for the transmission of the correction information corresponding to the identification information; and

transmission control for transmitting the correction information stored by the storage control step as related with the identification information to the another information processing apparatus if the request is received by the reception control step.

According to the thirty-second aspect of the present invention, there is provided an information processing apparatus for taking video data by an imaging apparatus to create content, including:

requesting means for requesting the transmission of the video data taken by the imaging apparatus and identification information for identifying the imaging apparatus to another information processing apparatus to request for the correction of the video data; and

receiving means for receiving the corrected video data from the another information processing apparatus.

According to the thirty-third aspect of the present invention, there is provided an information processing method for information processing apparatus for taking video data by an imaging apparatus to create content, including the steps of:

requesting the transmission of the video data taken by the imaging apparatus and identification information for identifying the imaging apparatus to another information processing apparatus to request for the correction of the video data; and

receiving the corrected video data from the another information processing apparatus.

According to the thirty-fourth aspect of the present invention, there is provided a recording medium storing a computer-readable program for an information processing apparatus for taking video data by an imaging apparatus to create content, including the steps of:

request control for requesting the transmission of the video data taken by the imaging apparatus and identification information for identifying the imaging apparatus to another information processing apparatus to request for the correction of the video data; and

reception control for receiving the corrected video data from the another information processing apparatus.

According to the thirty-fifth aspect of the present invention, there is provided a program for causing a computer for an information processing apparatus for taking video data by an imaging apparatus to create content to execute the steps of:

request control for requesting the transmission of the video data taken by the imaging apparatus and identification information for identifying the imaging apparatus to another information processing apparatus to request for the correction of the video data; and

reception control for receiving the corrected video data from the another information processing apparatus.

According to the thirty-sixth aspect of the present invention, there is provided an information processing apparatus including:

first receiving means for receiving video data taken by an imaging apparatus, identification information for identifying the imaging apparatus, and a request for the correction of the video data from a first another apparatus;

requesting means for requesting a second another information processing apparatus for correction information unique to each model of the imaging apparatus for correcting the video data taken by the imaging apparatus, the correction information corresponding to the identification information received by the first receiving means;

second receiving means for receiving the correction information from the second another information processing apparatus;

correcting means for correcting the video data by the correction information received by the second receiving means; and

transmitting means for transmitting the video data corrected by the correcting means to the first another information processing apparatus.

According to the thirty-seventh aspect of the present invention, there is provided an information processing method including the steps of:

receiving video data taken by an imaging apparatus, identification information for identifying the imaging apparatus, and a request for the correction of the video data from a first another information processing apparatus;

requesting a second another information processing apparatus for correction information unique to each model of the imaging apparatus for correcting the video data taken by the imaging apparatus, the correction information corresponding to the identification information received by the first receiving step;

receiving the correction information from the second another information processing apparatus;

correcting the video data by the correction information received by the second receiving step; and

transmitting the video data corrected by the correcting step to the first another information processing apparatus.

According to the thirty-eighth aspect of the present invention, there is provided a recording medium storing a computer-readable program including the steps of:

reception control for receiving video data taken by an imaging apparatus, identification information for identifying the imaging apparatus, and a request for the correction of the video data from a first another information processing apparatus;

request control for requesting a second another information processing apparatus for correction information unique to each model of the imaging apparatus for correcting the video data taken by the imaging apparatus, the correction information corresponding to the identification information received by the first reception control step;

reception control for receiving the correction information from the second another information processing apparatus;

correction control for correcting the video data by the correction information received by the second reception control step; and

transmission control for transmitting the video data corrected by the correction control step to the first another information processing apparatus.

According to the thirty-ninth aspect of the present invention, there is provided a program for causing a computer to execute the steps of:

reception control for receiving video data taken by an imaging apparatus, identification information for identifying the imaging apparatus, and a request for the correction of the video data from a first another apparatus;

request control for requesting a second another information processing apparatus for correction information unique to each model of the imaging apparatus for correcting the video data taken by the imaging apparatus, the correction information corresponding to the identification information received by the first reception control step;

reception control for receiving the correction information from the second another information processing apparatus;

correction control for correcting the video data by the correction information received by the second reception control step; and

transmission control for transmitting the video data corrected by the correction control step to the first another information processing apparatus.

### BRIEF DESCRIPTION OF THE DRAWINGS

These and other objects of the invention will be seen by reference to the description, taken in connection with the accompanying drawing, in which:

FIG. 1 is a schematic diagram illustrating a configuration of a service providing system practiced as one embodiment of the invention;

FIG. 2 is a schematic diagram illustrating an overview of the services to be provided by the service providing system of FIG. 1;

FIG. 3 is a perspective view illustrating an external view of an omnidirectional camera;

FIG. 4 is a block diagram illustrating an exemplary configuration of the omnidirectional camera;

FIG. 5 is a block diagram illustrating an exemplary configuration of a camera VTR maker server;

FIG. 6 is a block diagram illustrating an exemplary configuration of a hardware data center server;

FIG. 7 is a block diagram illustrating an exemplary configuration of a set-top box maker server;

FIG. 8 is a block diagram illustrating an exemplary configuration of a broadcasting station server;

FIG. 9 is a block diagram illustrating an exemplary configuration of a video tape recorder;

FIG. 10 is a block diagram illustrating an exemplary configuration of an STB (set-top box);

FIG. 11 is a block diagram illustrating an exemplary configuration of a transmitting apparatus;

FIG. 12 is a flowchart describing device ID registration processing;

FIG. 13 is a flowchart describing authentication key acquisition processing;

FIG. 14 is a flowchart describing authentication key embedding processing to be executed by an STB maker server;

FIG. 15 is a flowchart describing meta data acquisition processing;

FIG. 16 is a flowchart describing imaging recording processing;

FIG. 17 is a flowchart describing broadcasting processing;

FIG. 18 is a flowchart describing viewing processing to be executed by the STB;

FIG. 19 is a schematic diagram illustrating a configuration of a service providing system practiced as another embodiment of the invention;

FIG. 20 is a schematic diagram illustrating an overview of services to be provided by the service providing system of FIG. 19;

FIG. 21 is another flowchart describing the broadcasting processing;

FIG. 22 is a flowchart describing viewing processing;

FIG. 23 is a schematic diagram illustrating a configuration of a service providing system practiced as still another embodiment of the invention;

FIG. 24 is a schematic diagram illustrating a configuration of a service providing system practiced as yet another embodiment of the invention;

FIG. 25 is a schematic diagram illustrating an overview of services to be provided by the service providing system of FIG. 24;

FIG. 26 is a block diagram illustrating an exemplary configuration of a content provider server;

FIG. 27 is a block diagram illustrating an exemplary configuration of an authoring studio server;

FIG. 28 is a block diagram illustrating an exemplary configuration of an authoring apparatus;

FIG. 29 is a flowchart describing the correction processing by the content provider server;

FIG. 30 is a flowchart describing the correction processing by the authoring studio server;

FIG. 31 is a flowchart describing the correction processing by an HDC (hardware data center) server;

FIG. 32 is a flowchart describing the correction processing by a finance server;

FIG. 33 is a flowchart describing the correction processing by the authoring apparatus;

FIG. 34 is a schematic diagram illustrating a configuration of a service providing system practiced as a different embodiment of the invention; and

FIG. 35 is a schematic diagram illustrating an overview of services to be provided by the service providing system of FIG. 34.

### DETAILED DESCRIPTION OF THE PREFERRED EMBODIMENTS

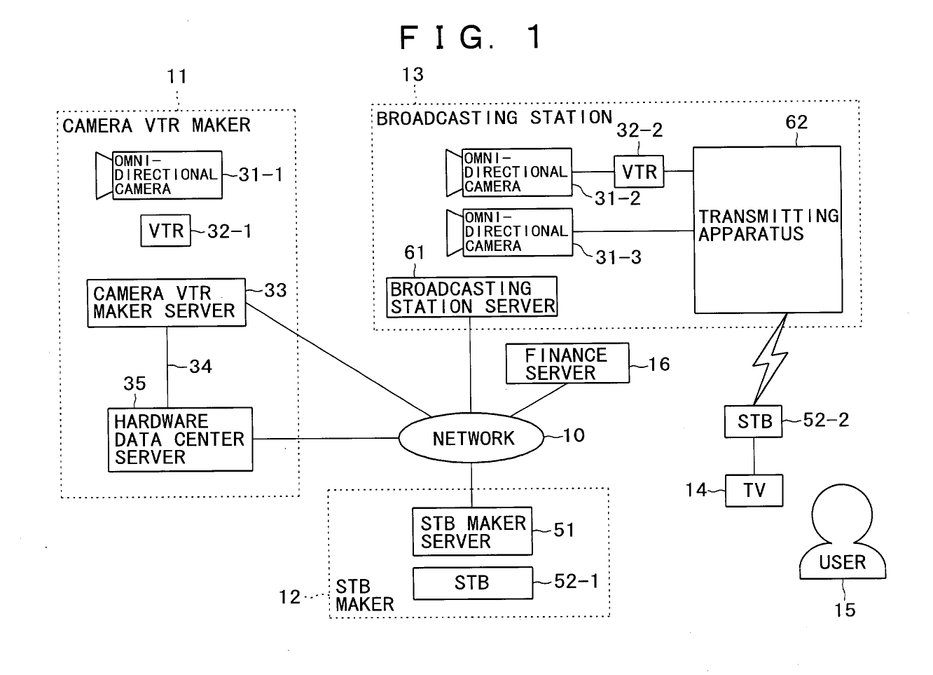

The present invention will be described in further detail by way of example with reference to the accompanying drawings. Now, with reference to FIG. 1, there is shown an exemplary configuration of a service providing system to which the present invention is applied.

In this service providing system, a finance server 16, a camera VTR maker server 33 of a camera VTR maker 11, a hardware data center server 35, an STB (set-top box) maker server 51 of an STB maker 12, and a broadcasting station server 61 of a broadcasting station 13 are connected to a network 10 such as the Internet.

The camera VTR maker 11 manufactures an omnidirectional camera 31-1 and a VTR (Video Tape Recorder) 32-1 and sells them to the broadcasting station 13 for example. The camera VTR maker server 33 in the camera VTR maker 11 records a device ID for identifying the product type and the product itself to a predetermined recording medium in each manufactured omnidirectional camera 31-1 or VTR 32-1. Also, the camera VTR maker server 33 gets the meta data (details of which will be described later) corresponding to the product type and requests an HDC (hardware data server) 35 to store the device ID and the acquired meta data in a related manner.

The HDC server 35 in the camera VTR maker 11 stores and manages, in a related manner, the device ID and meta data received from the camera VTR maker server 33 and the authentication key issued by the HDC server 35. If a request for an authentication key comes from the STB maker server 51, the HDC server 35 supplies the requested authentication key. In addition, if a request for meta data comes from the broadcasting station server 61, the HDC server 35 supplies the requested meta data and the authentication key.

The STB maker 12 manufactures an STB 52-1 and sells it to a user 15. The STB maker server 51 in the STB maker 12 gets the authentication key from the HDC server 35 and records it to a predetermined recording medium in the manufactured STB 52-1. The STB maker server 51 accesses the finance server 16 to execute the processing of remitting fees to a predetermined account.

The broadcasting station 13 purchases an omnidirectional camera 31-2 and a VTR 32-2 from the camera VTR maker 11 and, by use of the purchased omnidirectional camera 31-2 and VTR 32-2, takes and records omnidirectional images. The broadcasting station 13 multiplexes the recorded omnidirectional image with the meta data to broadcast the resultant image from a transmitting apparatus 62 via a broadcasting satellite for example.

The broadcasting station server 61 in the broadcasting station 13 gets the meta data and authentication key from the HDC server 35 and supplies the obtained meta data and authentication key to the transmitting apparatus 62 in a predetermined timing relation. The broadcasting station server 61 accesses the finance server 16 to execute the processing of paying the fee to a predetermined account.

The finance server 16 is a server installed at a bank or a finance company and executes the processing of paying fees (charging a predetermined account for the fee) to a predetermined account upon request from another server via the network 10.

The STB 52-2 purchased by the user 15 receives a broadcast transmitted from the transmitting apparatus 62 of the broadcasting station 13 and compares the authentication key included in the data in the broadcast (hereafter referred to as broadcast data) with the authentication key held in the STB 52-2 to determine whether or not the video data included in the received broadcast data are correctible. If the video data are found correctible, the STB 52-2 corrects the video data included in the broadcast data by the meta data multiplexed with the broadcast data and outputs the corrected video data to a television receiver 14 for displaying the corrected video data thereon.

It should be noted that, in what follows, if the omnidirectional camera 31-1 optical disk apparatus 1 and the omnidirectional camera 31-2 need not be distinguished from each other, they will be generically referred to as an omnidirectional camera 31. The same also holds with the other apparatuses.

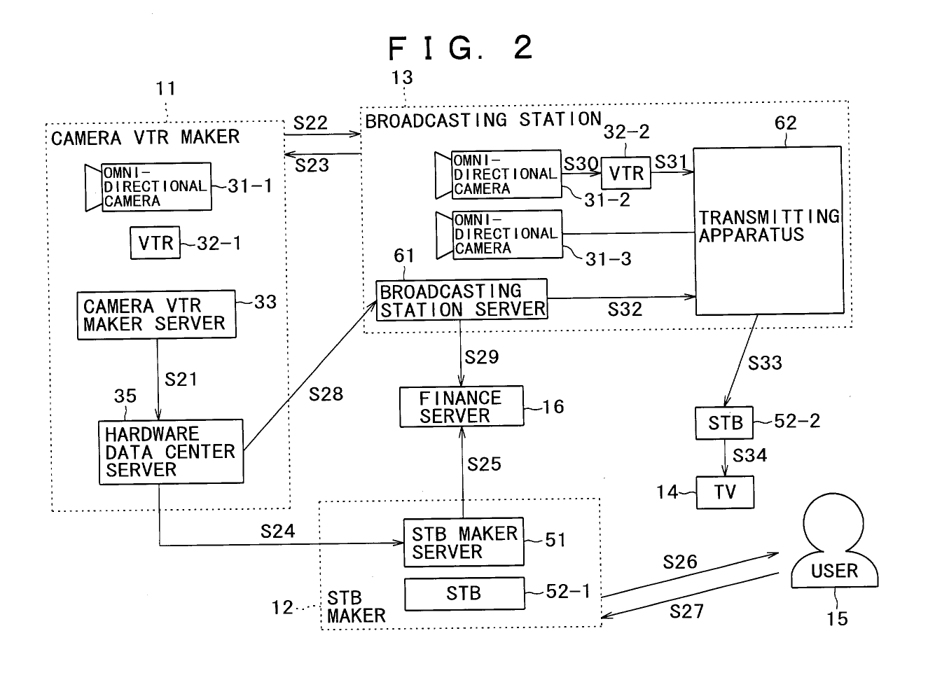

The following describes an overview of the service provision processing to be executed by the service providing system of the present invention with reference to FIG. 2.

In step S21 of FIG. 2, the camera VTR maker server 33 records the device IDs to the recording media in the omnidirectional camera 31-1 and the VTR 32-1 manufactured by the camera VTR maker 11 and, at the same time, requests the HDC server 35 to store the meta data for correcting the video data so that the video data captured and recorded by the omnidirectional camera 31-1 and the VTR 32-1 may be reproduced more clearly. The meta data are inputted by the manufacturer of the omnidirectional camera 31 for example and are stored as related with the device ID. In response to the request from the camera VTR maker server 33, the HDC server 35 stores the received meta data and the device ID in a related manner. At the same time, the HDC server 35 issues an authentication key and stores it as related with the device ID and the meta data.

In step S22, the camera VTR maker 11 delivers the required omnidirectional camera 31 and the VTR 32 to the broadcasting station 13. In step S23, the broadcasting station 13 pays the cost of the delivered omnidirectional camera 31 and VTR 32 to the camera VTR maker 11.

In step S24, in response to the request from the STB maker server 51, the HDC server 35 sends the stored authentication key to the STB maker server 51. The STB maker server 51 stores the received authentication key and, in step S25, accesses the finance server 16 to execute the processing of remitting a predetermined fee into the account of the camera VTR maker 11 for the provision of the authentication key.

Next, the STB maker server 51 records the acquired authentication key to a predetermined recording medium in the STB 52-1 manufactured by the STB maker 12.

In step S26, the STB maker 12 sells the STB 52-1 recorded with the authentication key to the user 15. In step S27, the user 15 pays the cost of the STB 52-1 to the STB maker 12. Actually, the STB 52 is sold at electrical appliance stores for example through given distribution channels.

In step S28, the broadcasting station server 61 sends the device IDs of the omnidirectional camera 31 and the VTR 32 purchased in step S22 to the HDC server 35 and gets the meta data and authentication key stored in the HDC server 35 in a related manner.

In step S29, the broadcasting station server 61 accesses the finance server 16 to execute the processing of paying a predetermined fee into the account of the camera VTR maker 11 for the provision of the meta data and authentication key.

In step S30, in the broadcasting station 13, predetermined imaging processing is executed with the omnidirectional camera 31-2 purchased from the camera VTR maker 11 and the captured image and audio data are recorded to a predetermined recording medium with the VTR 32-2. It should be noted that the device ID of the omnidirectional camera 31-2 and the device ID of the VTR 32-2 are also recorded along with the image and audio data to the recording medium.

In step S31, the VTR 32-2 sends the video and audio data and the device IDs recorded in step S30 to the transmitting apparatus 62. In step S32, the broadcasting station server 61 sends the meta data and authentication key acquired from the HDC server 35 in step S28 to the transmitting apparatus 62.

In step S33, the transmitting apparatus 62 multiplexes the received video and audio data, meta data, and authentication key together and broadcasts the multiplexed data and key via satellite broadcasting for example. Receiving the satellite broadcast, the STB 52-2 determines whether or not the authentication key included in the broadcast matches the authentication key recorded to the STB 52-2 and, if a match is found, corrects the video data included in the broadcast data by the meta data multiplexed with the broadcast data. Then, in step S34, the STB 52-2 outputs the corrected video data to the television receiver 14 for display thereon.

As described above, the service providing apparatus according to the invention allows the optimum video correction for every model of camera. Consequently, the user may view better video.

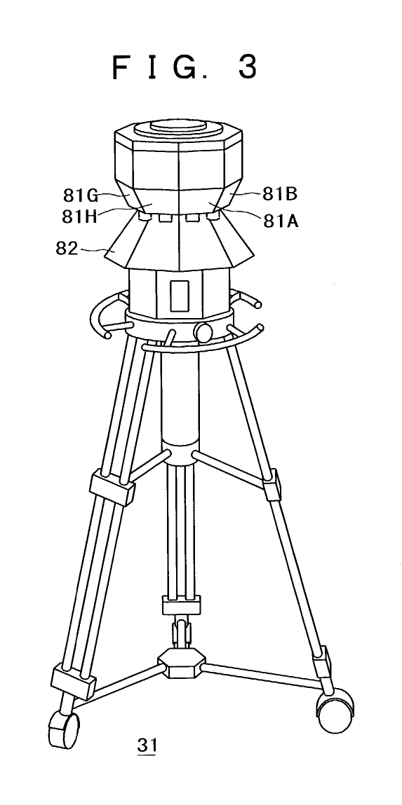

Referring to FIG. 3, there is shown an external view of the omnidirectional camera 31. As shown in FIG. 3, the omnidirectional camera 31 includes eight cameras 81A through 81H which are equidistantly arranged around an octagonal prism in predetermined radial directions and eight planar reflectors 82 arranged around an octagonal pyramid such that they reflect the lights to the corresponding cameras. It should be noted that the cameras 81A through 81H are also arranged such that their projection centers match at the proximity of the omnidirectional camera 31 and the sight line directions of the cameras are separated from each other by a predetermined angle on the same plane.

When each of the cameras 81A through 81H takes a picture reflected from its reflector, the omnidirectional camera 31 totally captures a mirror image panning 360 degrees in the horizontal direction. The video taken by each of the cameras 81A through 81H is captured into the computer via a video capture card as computer data (a bit map file) to be linked to the other videos taken by the other cameras into one omnidirectional video panning 360 degrees in the horizontal direction.

When the omnidirectional video thus generated is distributed by means of ground wave broadcasting, satellite broadcasting, cable television broadcasting, or high definition television broadcasting for example, the STB 52-2 extracts the angle of view specified by the user 15 and displays the extracted view on the television receiver 14. At this moment, the joint between the videos is not identifiable by the user, so that the user can view every desired view angle seamlessly from the entire omnidirectional video.

It should be noted that, if the user wants to slide the video to a desired degree, it is necessary for the STB 52 to perform geometrical corrections on the video by use of predetermined correction data such that the video is displayed as if it were rotating around the user. It is also necessary to perform color correction. The meta data mentioned above are the data for performing these geometrical and color corrections. The geometrical and color corrections by use of the meta data allow the user to feel as if he/she were looking at surrounding scenes in a natural manner.

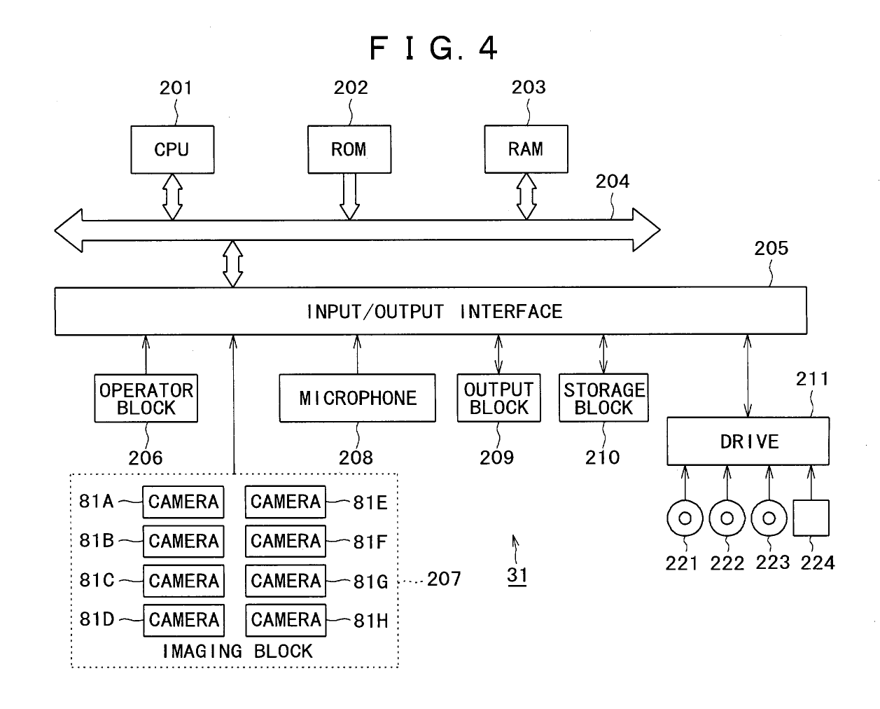

Referring to FIG. 4, there is shown a block diagram illustrating an internal configuration of the omnidirectional camera 31.

In FIG. 4, a CPU 201 executes various processing operations in accordance with programs stored in a ROM 202 or programs loaded from a storage block 210 into a RAM 203. The RAM 203 also suitably stores data which are necessary for the CPU 201 to execute various processing operations. The ROM 202 also stores the device ID of the omnidirectional camera 31.

The CPU 201, the ROM 202, and the RAM 203 are interconnected via a bus 204. The bus 204 is also connected to an input/output interface 205.

The input/output interface 205 is connected to an operator block 206 composed of a plurality of buttons for example for accepting operator inputs from the user, an imaging block 207 composed of cameras 81A through 81H, a microphone 208 for picking up surrounding audio, an output block 209 for outputting, to the outside (for example, the VTR 32), the video data captured by the imaging block 207 and the audio data picked up by the microphone 208, and the storage block 210 constituted by a hard disk for example.

The input/output interface 205 is connected to a drive 211 as required on which a magnetic disk 221, an optical disk 222, a magneto-optical disk 223, or a semiconductor memory 224 is suitably loaded. Computer programs are read from any of these storage media and are installed in the storage block 210 as required.

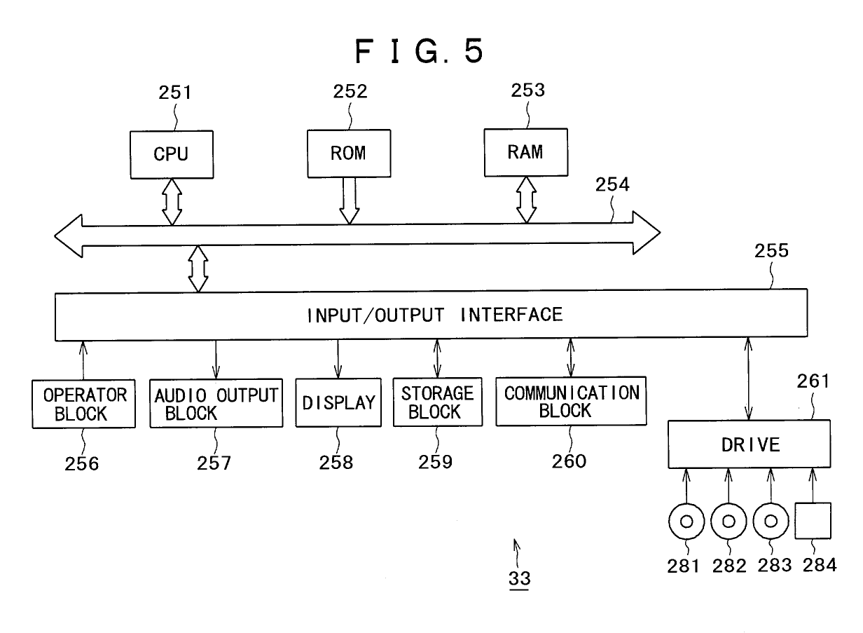

Referring to FIG. 5, there is shown a block diagram illustrating an internal configuration of the camera VTR maker server 33. As shown in FIG. 5, a CPU 251 executes various processing operations in accordance with programs stored in a ROM 252 or programs loaded from a storage block 259 into a RAM 253. The RAM 253 also suitably stores data which are necessary for the CPU 251 to execute various processing operations.

The CPU 251, the ROM 252, and the RAM 253 are interconnected via a bus 254. The bus 254 is also connected to an input/output interface 255.

The input/output interface 255 is connected to an operator block 256 composed of a plurality of buttons for example for accepting operator inputs from the user, an audio output block 257 for outputting audio, a display 258 constituted by a CRT (Cathode-Ray Tube) or an LCD (Liquid Crystal Display), the storage block 259 constituted by a hard disk for example, and a communication block 260 constituted by a modem and terminal adaptor for example. The communication block 260 performs communication processing via the network 10 such as the Internet.

The input/output interface 255 is connected to a drive 261 as required on which a magnetic disk 281, an optical disk 282, a magneto-optical disk 283, or a semiconductor memory 284 is suitably loaded. Computer programs are read from any of these storage media and are installed in the storage block 259 as required.

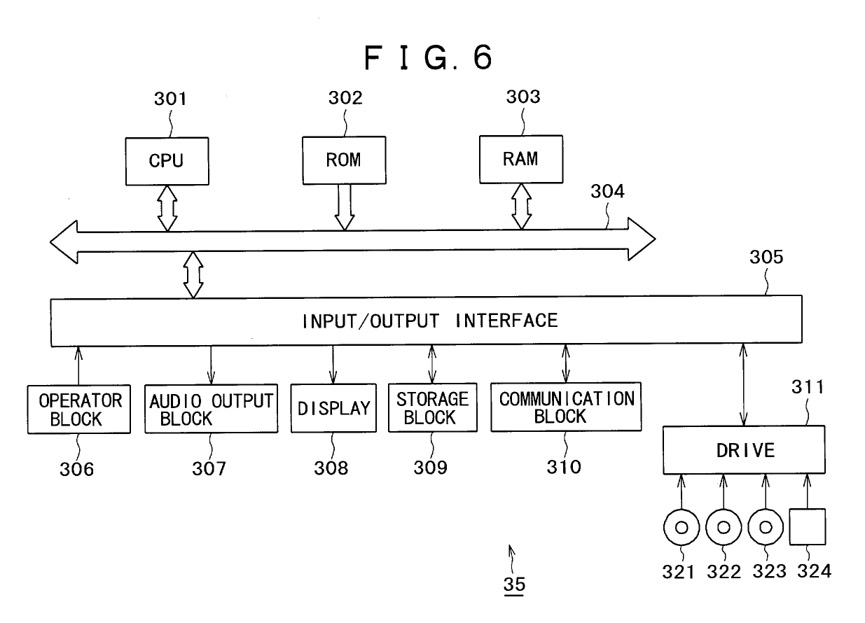

Referring to FIG. 6, there is shown a block diagram illustrating an internal configuration of the HDC server 35. The components, a CPU 301 through a semiconductor memory 324, which constitute the HDC server 35 are basically the same in configuration as the components, the CPU 251 through the semiconductor memory 284, which constitute the camera VTR maker server 33 shown on FIG. 5 and therefore the corresponding components shown in FIG. 6 have their corresponding functions shown in FIG. 5. Thus, the descriptions of these corresponding components will be skipped.

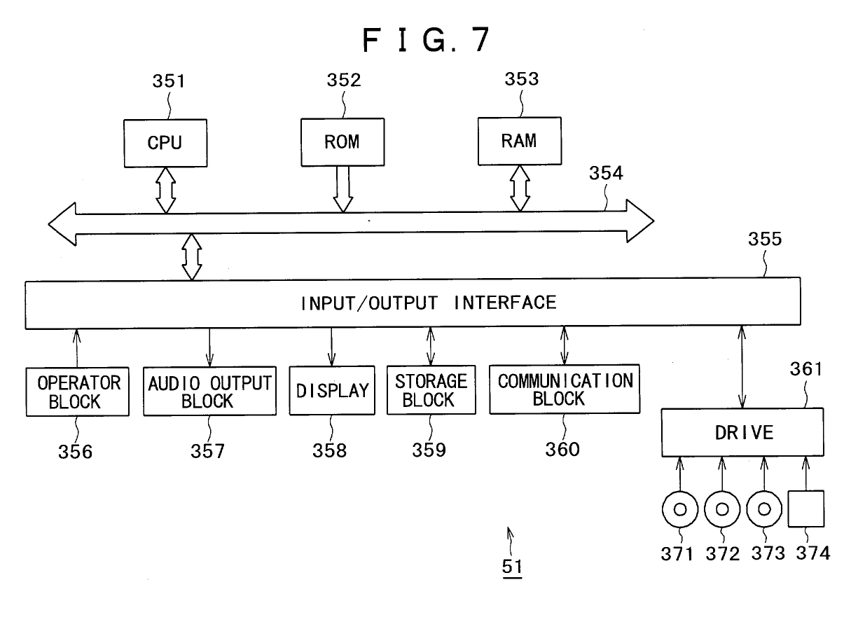

Referring to FIG. 7, there is shown a block diagram illustrating an internal configuration of the STB maker server 51. The components, a CPU 351 through a semiconductor memory 374, which constitute the STB maker server 51 are basically the same in configuration as the components, the CPU 251 through the semiconductor memory 284, which constitute the camera VTR maker server 33 shown on FIG. 5 and therefore the corresponding components shown in FIG. 7 have their corresponding functions shown in FIG. 5. Thus, the descriptions of these corresponding components will be skipped.

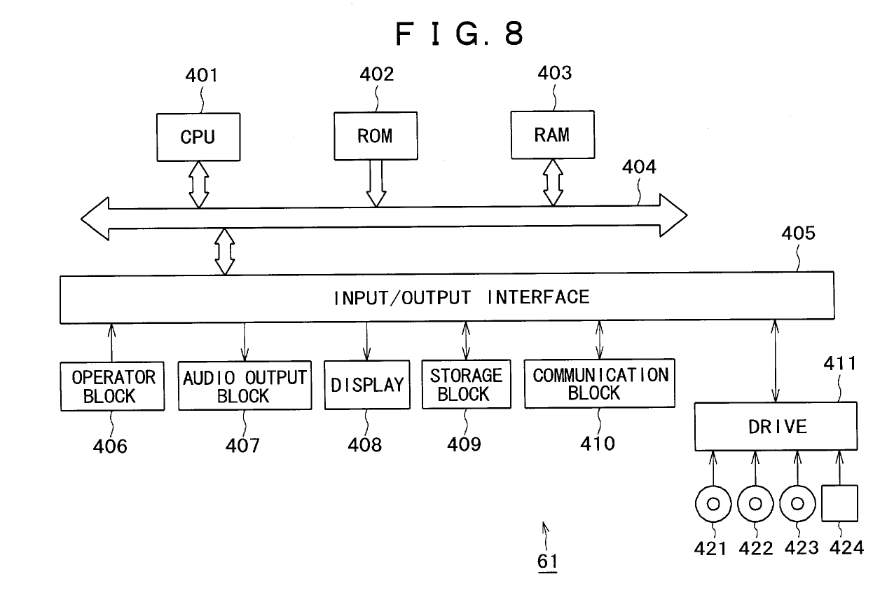

Referring to FIG. 8, there is shown a block diagram illustrating an internal configuration of the broadcasting station server 61. The components, a CPU 401 through a semiconductor memory 424, which constitute the broadcasting station server 61 are basically the same in configuration as the components, the CPU 251 through the semiconductor memory 284, which constitute the camera VTR maker server 33 shown on FIG. 5 and therefore the corresponding components shown in FIG. 8 have their corresponding functions shown in FIG. 5. Thus, the descriptions of these corresponding components will be skipped.

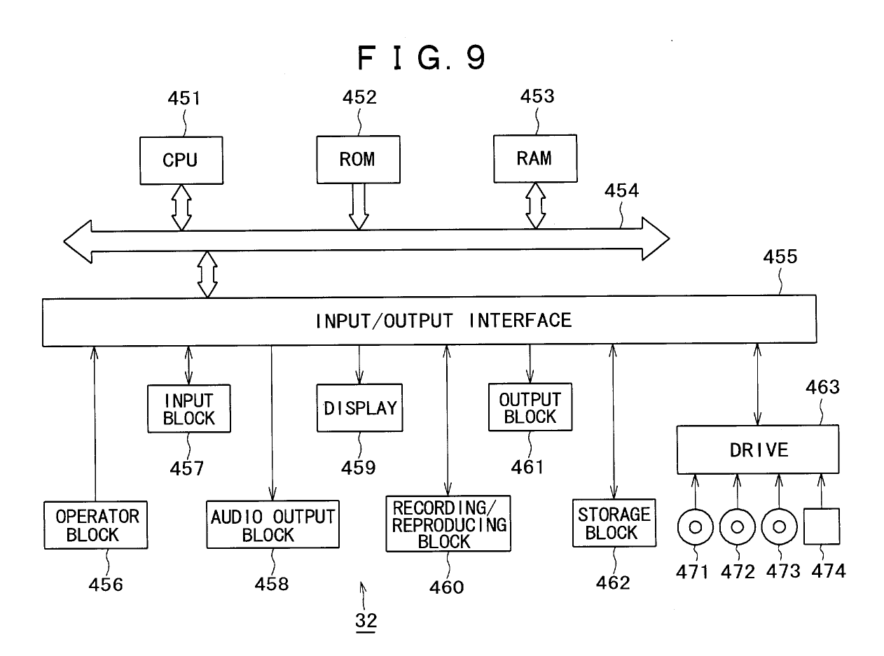

Referring to FIG. 9, there is shown an internal configuration of the VTR 32. As shown in FIG. 9, a CPU 451 executes various processing operations in accordance with programs stored in a ROM 452 or programs loaded from a storage block 462 into a RAM 453. The RAM 453 also suitably stores data necessary for the CPU 451 to execute various processing operations. The ROM 452 also stores the device ID of the VTR 32.

The CPU 451, the ROM 452, and the RAM 453 are interconnected via a bus 454. The bus 454 is also connected to an input/output interface 455.

The input/output interface 455 is connected to an operator block 456 constituted by a plurality of buttons for accepting operator inputs by the user, an input block 457 for inputting video data and audio data from the omnidirectional camera 31, an audio output block 458 for outputting audio, a display 459 constituted by a CRT or an LCD for example, a recording/reproducing block 460 for recording the video data and audio data inputted from the input block 457 to a predetermined recording medium and reproducing the video data and audio data therefrom, an output block 461 for outputting the video data and audio data reproduced by the recording/reproducing block 460 to the outside (for example, the transmitting apparatus 62), and the storage block 462 constituted by a hard disk for example. When recording video data and audio data to a predetermined recording medium, the recording/reproducing block 460 records the device ID received from the omnidirectional camera 31 and the device ID recorded in the ROM 452 of the VTR 32 along with the video data and the audio data.

The input/output interface 455 is also connected to a drive 463 as required, on which a magnetic disk 471, an optical disk 472, a magneto-optical disk 473, or a semiconductor memory 474 is suitably loaded. Computer programs are read from any of these storage media and are installed in the storage block 462 as required.

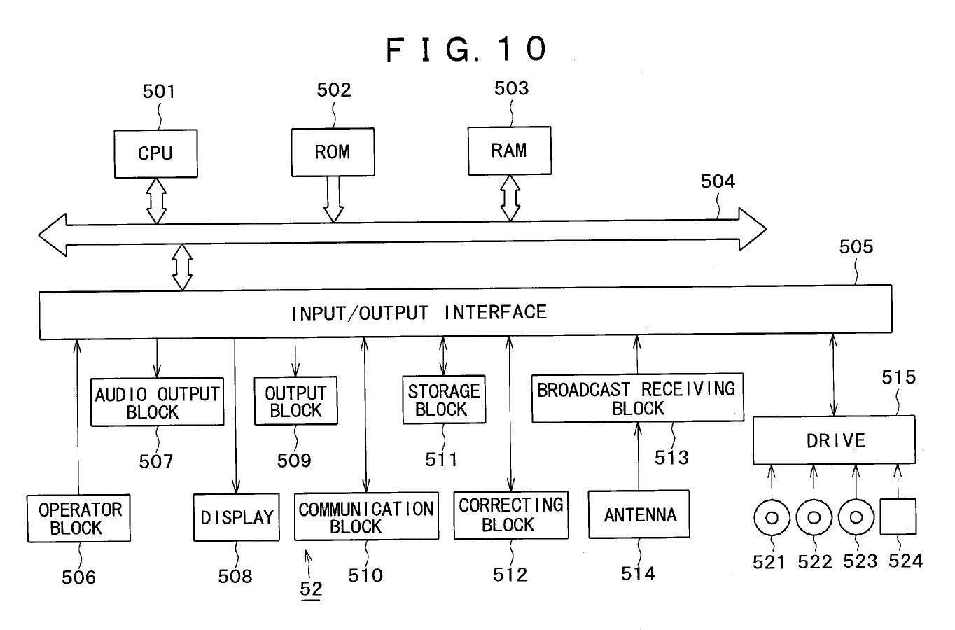

Referring to FIG. 10, there is shown a block diagram illustrating an internal configuration of the STB 52. As shown in FIG. 10, a CPU 501 executes various processing operations in accordance with programs stored in a ROM 502 or programs loaded from a storage block 511 into a RAM 503. The RAM 503 also suitably stores data necessary for the CPU 501 to execute various processing operations.

The CPU 501, the ROM 502, and the RAM 503 are interconnected via a bus 504. The bus 504 is also connected to an input/output interface 505.

The input/output interface 505 is connected to an operator block 506 constituted by a plurality of buttons for accepting operator inputs by the user, an audio output block 507 for outputting audio, a display 508 constituted by an LCD for example for displaying the operation condition of the STB 52, an output block 509 for outputting video data and audio data supplied from a broadcast receiving block 513 or a correcting block 512 to the outside (for example, the television receiver 14), a communication block 510 constituted by a modem and a terminal adaptor, the storage block 511 constituted by a hard disk for example, the correcting block 512 for correcting the video data by meta data when supplied with the video data and the meta data from the broadcast receiving block 513, and the broadcast receiving block 513 for receiving broadcast via an antenna 514. The communication block 510 perform communication processing via the network 10 such as the Internet.

The input/output interface 505 is also connected to a drive 515 as required, on which a magnetic disk 521, an optical disk 522, a magneto-optical disk 523, or a semiconductor memory 524 is suitably loaded. Computer programs are read from any of these storage media and are installed in the storage block 511 as required.

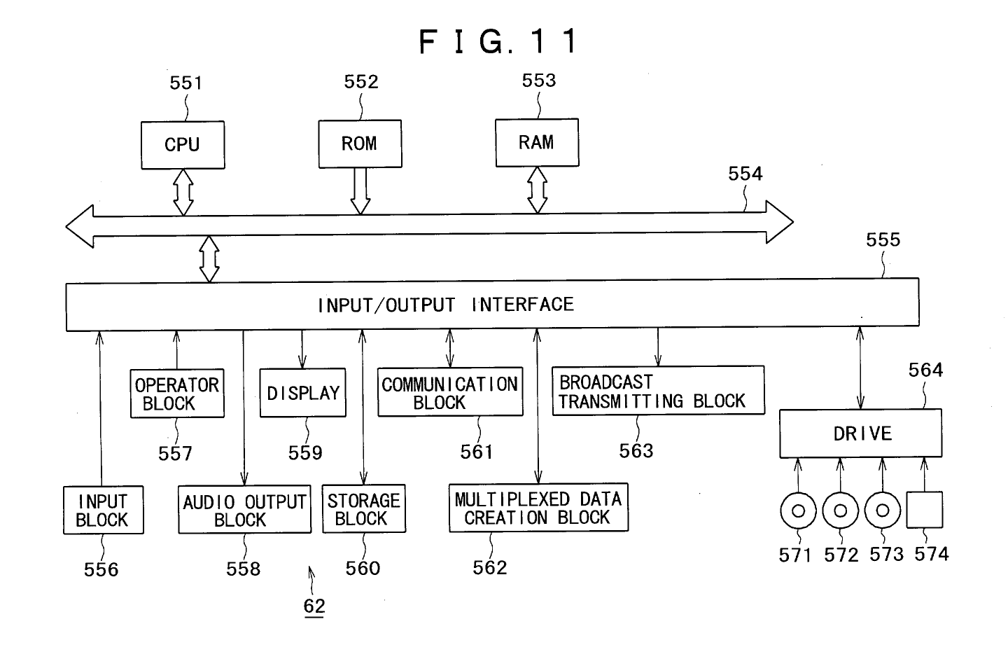

Referring to FIG. 11, there is shown an internal configuration of the transmitting apparatus 62. As shown in FIG. 11, a CPU 551 executes various processing operations in accordance with programs stored in a ROM 552 or programs loaded from a storage block 560 into a RAM 553. The RAM 553 also stores from time to time data necessary for the CPU 551 to execute various processing operations.

The CPU 551, the ROM 552, and the RAM 553 are interconnected via a bus 554. The bus 554 is also connected to an input/output interface 555.

The input/output interface 555 is connected to an input block 556 for inputting video data and audio data outputted from the omnidirectional camera 31 or the VTR 32, an operator block 557 constituted by a plurality of buttons for accepting operator inputs by the user, an audio output block 558 for outputting audio, a display 559 constituted by a CRT or an LCD for example, the storage block 560 constituted by a hard disk for example, a communication block 561 constituted by a modem and a terminal adaptor, a multiplexed data creation block 562 for creating data to be broadcast by multiplexing the video and audio data, device ID, meta data and authentication key inputted from the input block 556, and a broadcast transmitting block 563 for transmitting the multiplexed data generated by the multiplexed data creation block 562 as a satellite broadcast. The communication block 561 perform communication processing via the network 10 such as the Internet.

The input/output interface 555 is also connected to a drive 564 as required, on which a magnetic disk 571, an optical disk 572, a magneto-optical disk 573, or a semiconductor memory 574 is suitably loaded. Computer programs are read from any of these storage media and are installed in the storage block 560 as required.

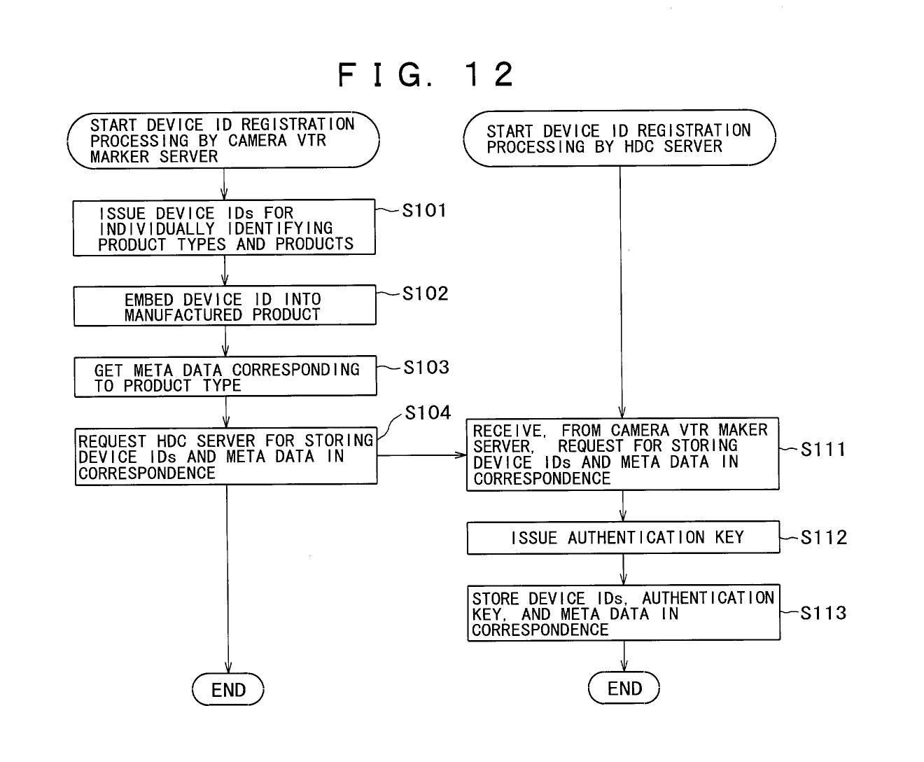

The following describes device ID registration processing with reference to the flowchart in FIG. 12.

In step S101, the CPU 251 of the camera VTR maker server 33 issues the device ID to each of the omnidirectional camera 31-1 and the VTR 32-1 manufactured by the camera VTR maker 11. This device ID is used to identify the type of the omnidirectional camera 31 or the VTR 32 and identify the product itself.

In step S102, the CPU 251 of the camera VTR maker server 33 records the device IDs issued in step S101 into the ROM 202 of the omnidirectional camera 31-1 and the ROM 452 of the VTR 32-1.

In step S103, the CPU 251 of the camera VTR maker server 33 receives the meta data for the omnidirectional camera 31 or the VTR 32 from the manufacturer of the omnidirectional camera 31 or the VTR 32 through the operator block 256 for example. In step S104, the CPU 251 sends the device IDs issued in step S101 and the meta data acquired in step S103 to the HDC server 35 via the communication block 260 to request the HDC server 35 to store these IDs and meta data in a related manner.

In step S111, the CPU 301 of the HDC server 35 receives the device ID and the meta data and the request from the camera VTR maker server 33 for storing them in a related manner. In step S112, the CPU 301 of the HDC server 35 issues the authentication key corresponding to the device ID and the meta data. In step S113, the CPU 301 of the HDC server 35 stores, in the storage block 309, the device ID and meta data received in step S111 and the authentication key issued in step S112 in a related manner.

As described, a database of a table listing the device ID, the meta data, and the authentication key related with each other is created in the storage block 309 of the HDC server. The device ID is recorded to each of the omnidirectional camera 31 and the VTR 32 manufactured by the camera VTR maker 11.

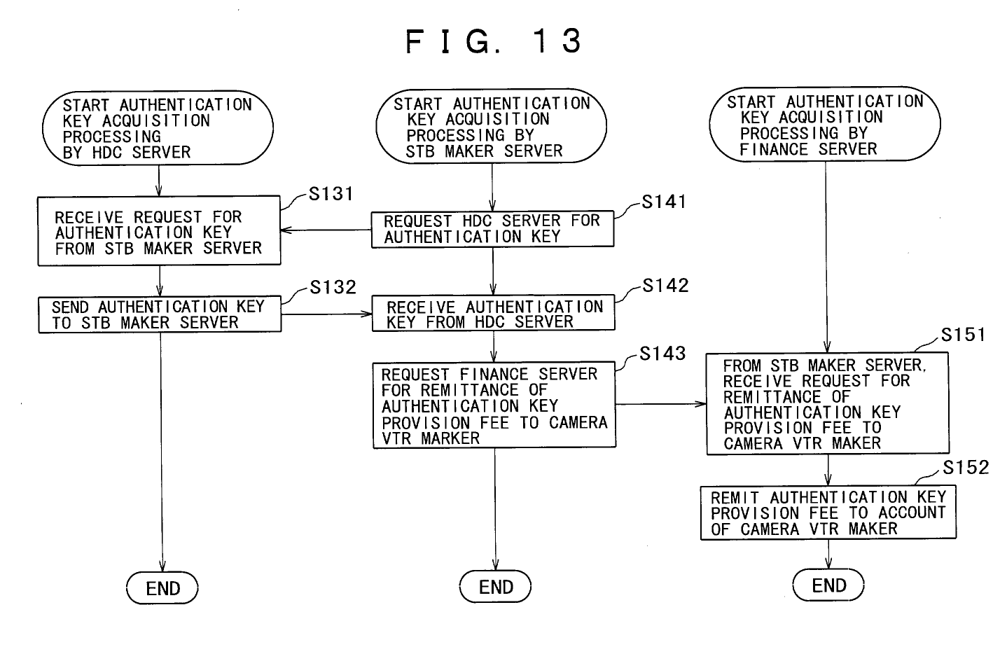

The following describes authentication key acquisition processing with reference to the flowchart shown in FIG. 13.

In step S141, the CPU 351 of the STB maker server 51 requests, via the communication block 360, the HDC server 35 to send an authentication key. In step S131, the CPU 301 of the HDC server 35 receives the request for the authentication key from the STB maker server 51. In step S132, the CPU 301 of the HDC server 35 reads the authentication key from the storage block 309 and sends the retrieved authentication key to the STB maker server 51 via the communication block 310.

In step S142, the CPU 351 of the STB maker server 51 receives the authentication key from the HDC server 35 and stores the received authentication key in the storage block 359. Next, in step S143, the CPU 351 of the STB maker server 51 accesses the finance server 16 to request for the remittance of the cost of a predetermined amount for the authentication key provision fee into the account of the camera VTR maker 11.

In step S151, the finance server 16 receives, from the STB maker server 51, the request from the STB maker server 51 for the remittance of the cost of a predetermined amount set beforehand as the authentication key provision fee into the account of the camera VTR maker 11. In step S152, the finance server 16 executes the processing of remitting the cost of a predetermined amount set beforehand as the authentication key provision fee into the account of the camera VTR maker 11.

Thus, the authentication key acquisition processing has been performed.

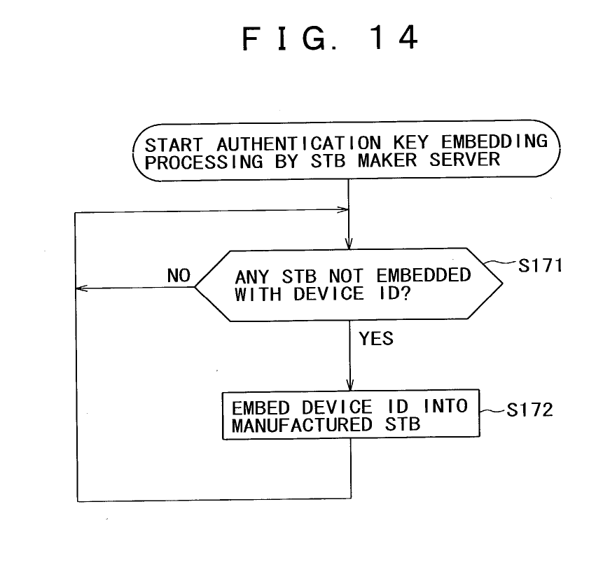

The following describes authentication key embedding processing with reference to the flowchart shown in FIG. 14.

In step S171, the CPU 351 of the STB maker server 51 checks the STBs 52-1 manufactured by the STB maker 12 for any STB 52-1 that records no authentication key. If such a STB 52-1 is not found, the CPU 351 repeats the process of step S171. If the CPU 351 of the STB maker server 51 finds any STB 52-1 recording no authentication key, the procedure goes to step S172, in which the CPU 351 reads the authentication key received and stored in the storage block 359 in step S142 and records the retrieved authentication key into the ROM 502 of the STB 52-1. Then, the procedure returns to step S171 to repeat the processing therefrom.

Thus, the authentication key is stored in all STBs 52-1 manufactured by the STB maker 12.

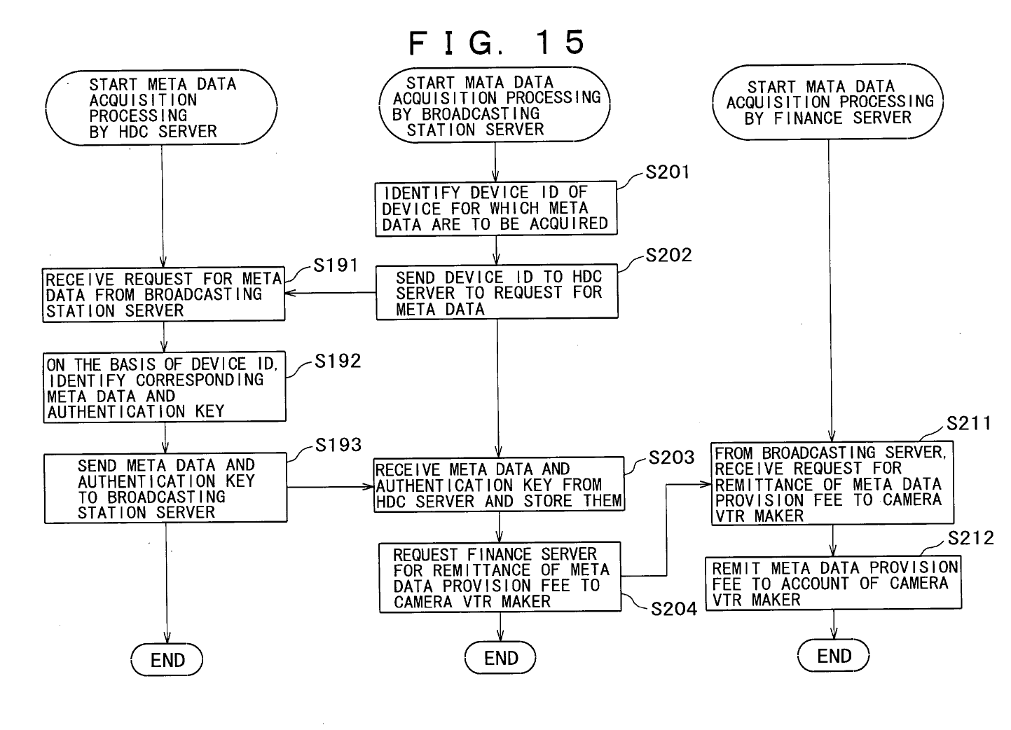

The following describes meta data acquisition processing with reference to the flowchart shown in FIG. 15.

In step S201, the CPU 401 of he broadcasting station server 61 gets the device ID of the device for which meta data are to be acquired. To be more specific, the producer of a program to be broadcast enters the device IDs of the omnidirectional camera 31-2 and the VTR 32-2 to be used for the production of the program, by operating the operator block 406 of the broadcasting station server 61 for example.

In step S202, the CPU 401 of the broadcasting station server 61 sends the device ID to the HDC server 35 and requests the HDC server 35 to supply the meta data corresponding to the device ID.

In step S191, the CPU 301 of the HDC server 35 receives the device ID and the request for the supply of the meta data corresponding to this device ID from the broadcasting station server 61 via the communication block 310. In step S192, on the basis of the device ID received in step S191, the CPU 301 of the HDC server 35 reads the meta data and authentication key stored in the storage block 409 in a related manner. In step S193, the CPU 301 of the HDC server 35 sends the meta data and authentication key read in step S192 to the broadcasting station server 61 via the communication block 310.

In step S203, the CPU 401 of the broadcasting station server 61 receives the meta data and the authentication key from the HDC server 35 via the communication block 410 and stores them in the storage block 409.

In step S204, the CPU 401 of the broadcasting station server 61 requests, through the communication block 410, the finance server 16 to remit the cost of a predetermined amount set beforehand as the fee for the provision of the meta data to the account of the camera VTR maker 11.

In step S211, the finance server 16 receives the request from the broadcasting station server 61 for remitting the cost of a predetermined amount set beforehand as the fee for the provision of the meta data to the account of the camera VTR maker 11. In step S212, the finance server 16 remits the cost of a predetermined amount set beforehand as the fee for the meta data to the account of the camera VTR maker 11.

Thus, the meta data acquisition processing is executed.

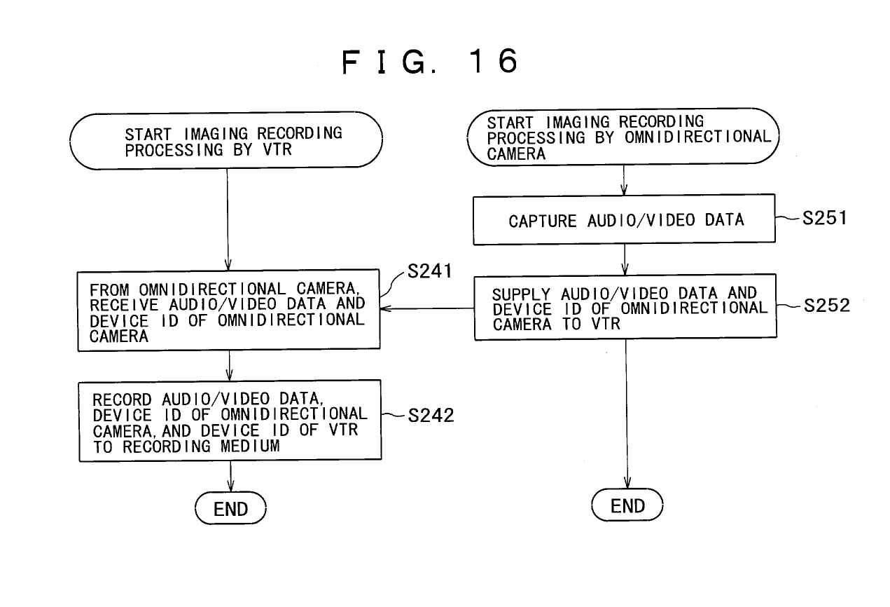

The following describes imaging recording processing with reference to the flowchart shown in FIG. 16.

In step S251, the CPU 201 of the omnidirectional camera 31-2 drives the imaging block 207 and the microphone 208 to capture video data and audio data. In step S252, the CPU 201 of the omnidirectional camera 31-2 outputs the video data and audio data captured in step S251 and the device ID of the omnidirectional camera 31-2 recorded in the ROM 402 to the VTR 32-2 through the output block 209.

In step S241, the CPU 451 of the VTR 32-2 receives the video data, the audio data and the device ID of the omnidirectional camera 31-2 from the omnidirectional camera 31-2 through the input block 457. In step S242, the CPU 451 of the VTR 32-2 drives the recording/reproducing block 460 to record the video data, the audio data, and the device ID of the omnidirectional camera 31-2 inputted in step S241 and the device ID of the VTR 32-2 stored in the ROM 452 to a predetermined recording medium loaded on the VTR 32-2 beforehand.

As described, the video data, audio data, the device ID of the omnidirectional camera 31-2, and the device ID of the VTR 32-2 are recorded to the recording medium loaded on the VTR 32-2.

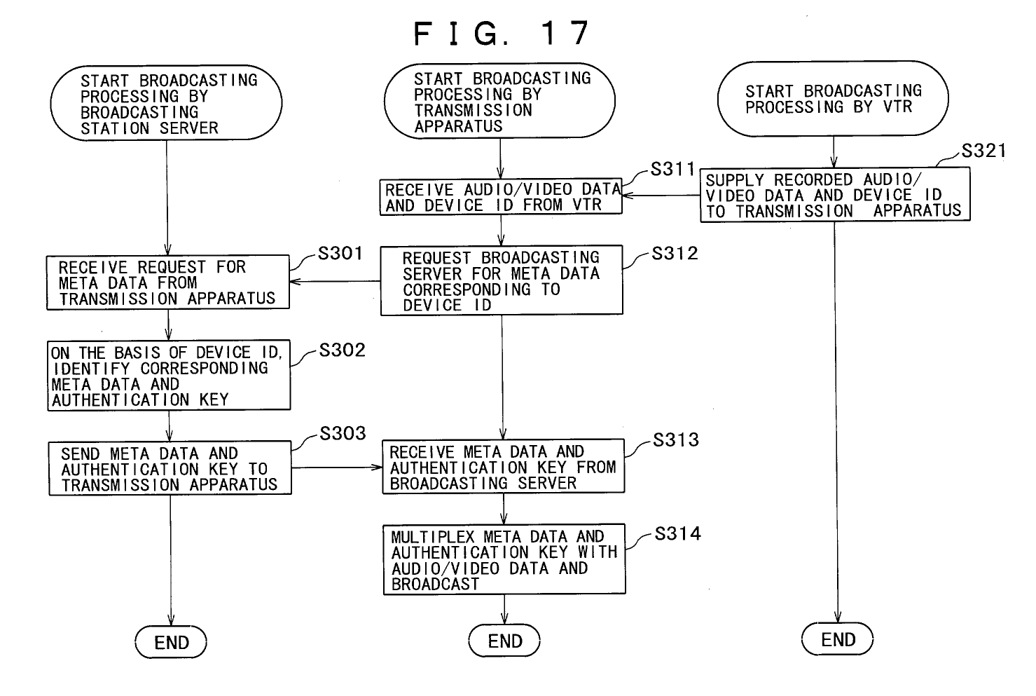

The following describes broadcasting processing with reference to the flowchart shown in FIG. 17.

In step S321, the CPU 451 of the VTR 32-2 drives the recording/reproducing block 460 to read the video data, the audio data, the device ID of the omnidirectional camera 31-2 and the device ID of the VTR 32-2 recorded to the predetermined recording medium as shown in the flowchart of FIG. 16 and outputs these data and device IDs to the transmitting apparatus 62 through the output block 461.

In step S311, the CPU 551 of the transmitting apparatus 62 receives, through the input block 556, the video data, the audio data, the device ID of the omnidirectional camera 31-2, and the device ID of the VTR 32-2 form the VTR 32-2 and stores these data and device IDs into the storage block 560.

In step S312, the CPU 551 of the transmitting apparatus 62 sends the device IDs of the omnidirectional camera 31-2 and the VTR 32-2 inputted in step S311 to the broadcasting station server 61 and requests the broadcasting station server 61 to supply the meta data corresponding to the device IDs.

In step S301, the CPU 401 of the broadcasting station server 61 receives the device IDs of the omnidirectional camera 31-2 and the VTR 32-2 and the request for the supply of the meta data corresponding to the device IDs from the transmitting apparatus 62. In step S302, the CPU 401 of the broadcasting station server 61 reads the meta data and authentication keys stored in the storage block 409 in a related manner. In step S303, the CPU 401 of the broadcasting station server 61 sends the meta data and the authentication keys read in step S302 to the transmitting apparatus 62 through the communication block 410.

In step S313, the CPU 551 of the transmitting apparatus 62 receives the meta data and the authentication keys from the broadcasting station server 61 through the communication block 51. In step S314, the CPU 551 of the transmitting apparatus 62 instructs the multiplexed data creation block 562 to multiplex the meta data and the authentication keys received in step S313 with the video data and the audio data received and stored in step S311 to create multiplexed data. Then, the CPU 551 supplies the created multiplexed data to the broadcast transmitting block 563 from the multiplexed data creation block 562 to broadcast the multiplexed data from the broadcast transmitting block 563 as a satellite broadcast.

It should be noted that, in the above description, the video taken by the omnidirectional camera 31-2 is once recorded in the VTR 32-2 before being transmitted to the transmitting apparatus 62. It is also practicable to send the video data taken by the omnidirectional camera 31-3 shown in FIG. 1 directly to the transmitting apparatus 62 without storing the data in the VTR 32, for example. In this case, the video taken by the omnidirectional camera 31-3 is broadcast in real-time from the transmitting apparatus 62 (this is so-called live broadcasting).

Thus, broadcast data multiplexed with the meta data and the authentication keys are broadcast from the transmitting apparatus 62. The broadcast data thus transmitted are received by the STB 52-2 to be viewed by the user 15 through the television receiver 14.

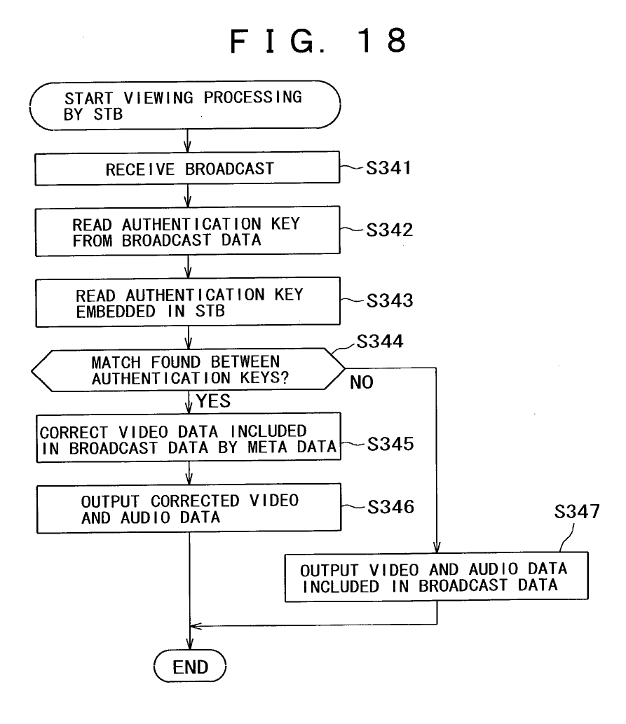

The following describes the broadcast viewing processing by the STB 52-2 with reference to the flowchart shown in FIG. 18.

In step S341, the CPU 501 of the STB 52-2 receives, through the antenna 514 and the broadcast receiving block 513, the broadcast data of the program being broadcast by the broadcasting station 13. In step S432, the CPU 501 of the STB 52-2 reads the authentication key multiplexed with the broadcast data received in step S341. In step S343, the CPU 501 of the STB 52-2 reads the authentication key from the ROM 502. In step S344, the CPU 501 compares the authentication key read from the broadcast data in step S342 with the authentication key read from the ROM 502 in step S343. If a match is found, the procedure goes to step S345.

In step S345, the CPU 501 of the STB 52-2 instructs the correcting block 512 to correct the video data included in the broadcast data by the meta data multiplexed with the broadcast data. In step S346, the CPU 501 outputs the video data corrected in step S345 and the audio data included in the broadcast data to the television receiver 14 through the output block 509. The television receiver 14 displays the video data supplied from the STB 52-2 on its display and sounds the audio data from its speaker. Consequently, the user can view the corrected video.

In step S344, if the CPU 501 of the STB 52-2 determines that there is no match between the authentication key read from the broadcast data in step S342 and the authentication key read from the ROM 502 in step S343, then the procedure goes to step S347, in which the CPU 501 of the STB 52-2 outputs the video data and audio data included in the broadcast data received in step S341 to the television receiver 14 from the output block 509. The television receiver 14 displays the video data supplied from the STB 52-2 on its display and sounds the audio data from its speaker. In this case, the user views the uncorrected video on the display.

Thus, if the STB 52-2 has the authentication key, the video data included in broadcast data are corrected by the meta data multiplexed with the broadcast data and the corrected video data are displayed on the television receiver 14.

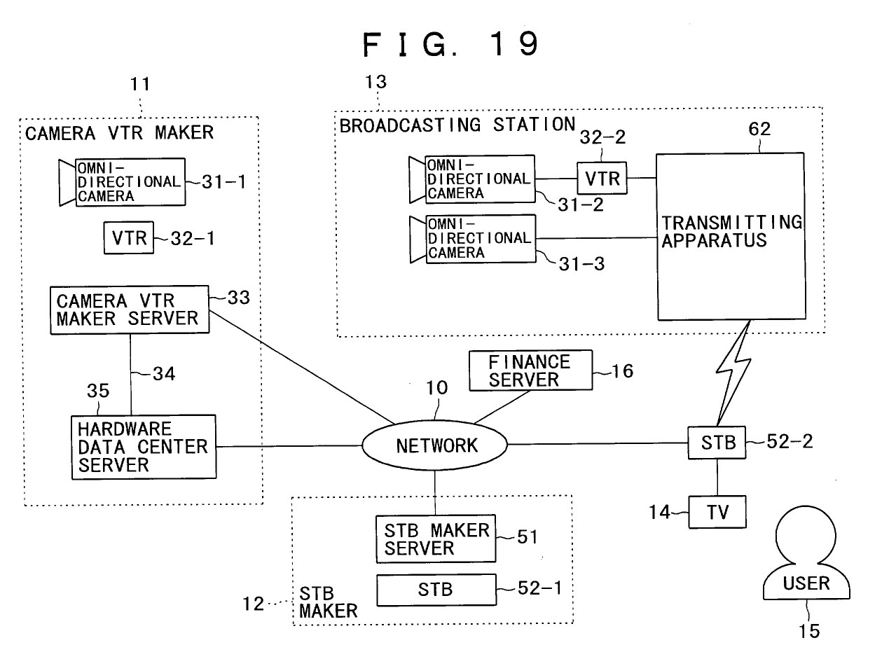

Now, referring to FIG. 19, there is shown a configuration of a service providing system practiced as another embodiment of the invention, which is different from the configuration shown in FIG. 1. With reference to FIG. 19, components similar to those previously described with reference to FIG. 1 are denoted by the same reference numerals. In the configuration shown in FIG. 19, the STB 52-2 is connected to the network 10. The broadcasting station server 61 shown in FIG. 1 is omitted from the configuration shown in FIG. 19.

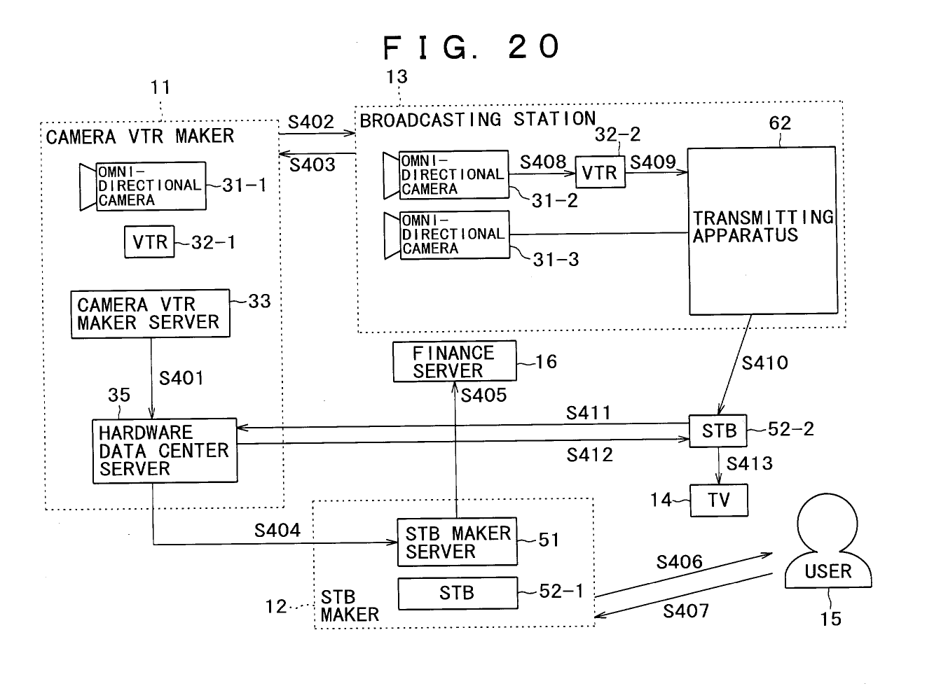

The following describes the overview of the service providing system shown in FIG. 19 with reference to FIG. 20.

In step S401 of FIG. 20, a camera VTR maker server 33 records the device IDs to the recording media in the omnidirectional camera 31-1 and the VTR 32-1 manufactured by the camera VTR maker 11 and requests the HDC server 35 to store the meta data inputted by the manufacturer of the omnidirectional camera 31 for example by relating the meta data with these device IDs. In response to this request by the camera VTR maker server 33, the HDC server 35 stores the received device IDs and meta data in a related manner. In addition, the HDC server 35 issues authentication keys and stores them as related with the device IDs and the meta data.

In step S402 shown in FIG. 20, the camera VTR maker 11 delivers the specified omnidirectional camera 31 and the VTR 32 to the broadcasting station 13. In step S403, the broadcasting station 13 pays the costs for the omnidirectional camera 31 and the VTR 32 to the camera VTR maker 11.

In step S404, in response to the request from the STB maker server 51, the HDC server 35 sends the stored authentication key. The STB maker server 51 stores the authentication key received from the HDC server 35 and accesses the finance server 16 in step S405 to execute the processing of remitting a predetermined amount of cost to the account of the camera VTR maker 11.

Then, the STB maker server 51 records the acquired authentication key to a predetermined recording medium in the STB 52-1 manufactured by the STB maker 12.

In step S406, the STB maker 12 sells the STB 52-1 recorded with the authentication key to the user 15. In step S407, the user 15 pays the cost for the STB 52-1 to the STB maker 12. Actually, the STB 52 is sold at electrical appliance stores for example through given distribution channels.

In step S408, the broadcasting station 13 executes predetermined imaging processing by use of the omnidirectional camera 31-2 purchased from the camera VTR maker 11. The captured video data and audio data are recorded to a predetermined recording medium through the VTR 32-2. It should be noted that, in doing so, the device ID of the omnidirectional camera 31-2 and the device ID of the VTR 32-2 are also recorded along with the captured video and audio data.

In step S409, the VTR 32-2 sends the video and audio data and the device ID recorded in step S408 to the transmitting apparatus 62.

In step S410, the transmitting apparatus 62 multiplexes received video and audio data and device ID together and broadcasts the multiplexed data as a satellite broadcast. Receiving the satellite broadcast, the STB 52-2 sends the device ID multiplexed with the broadcast data to the HDC server 35 in step S411. The HDC server 35 reads the meta data corresponding to the received device ID and sends the retrieved meta data to the STB 52-2 in step S412. The STB 52-2 corrects the video data included in the broadcast data by the received meta data. In step S413, the STB 52-2 outputs the corrected video data to the television receiver 14 for display thereon.

As described, like the service providing system shown in FIG. 1, the service providing system according to the invention shown in FIG. 19 can provide optimum video correction for each model of camera. This allows the user to view the video of better quality.

It should be noted that the service providing system shown in FIG. 19 also executes the same processing as that described with reference to the flowcharts shown in FIGS. 12 through 14 and 16. Namely, the device IDs, the authentication keys, and the meta data are stored in the HDC server 35 in a related manner by the processing described by the flowchart shown in FIG. 12. In the processing described by the flowchart shown in FIG. 13, the STB maker server 51 gets the authentication key and remits the cost thereof to the account of the camera VTR maker 11. In the processing described by the flowchart shown in FIG. 14, the authentication key is stored in the ROM 502 of the STB 52-1 manufactured by the STB maker 12. In the processing described by the flowchart shown in FIG. 16, the video data and audio data taken by the omnidirectional camera 31-2 and the device IDs are recorded to a predetermined recording medium loaded on the VTR 32-2.

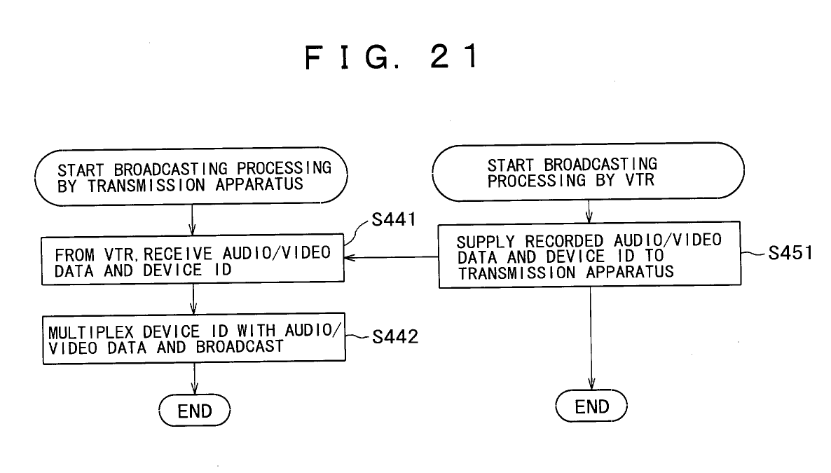

The following describes the broadcasting processing to be executed in the service providing system shown in FIG. 19 with reference to the flowchart shown in FIG. 21.

In step S451, the CPU 451 of the VTR 32 drives the recording/reproducing block 450 to read the video data, audio data, and device IDs from a predetermined recording medium and outputs them to the transmitting apparatus 62 through the output block 461.

In step S441, the CPU 551 of the transmitting apparatus 62 receives the video data, the audio data, and the device IDs from the VTR 32-2 via the input block 556. In step S442, the CPU 551 of the transmitting apparatus 62 instructs the multiplexed data creation block 562 to multiplex the video data, the audio data, and the device ID received in step S441 together. Then the CPU 551 transmits the multiplexed data created by the multiplexed data creation block 562 from the broadcast transmitting block 563 as a broadcast.

Consequently, the broadcast data multiplexed with the video data, the audio data, and the device ID are transmitted.

The transmitted broadcast data are received by the STB 52-2 and displayed on the television receiver 14 for viewing by the user 15.

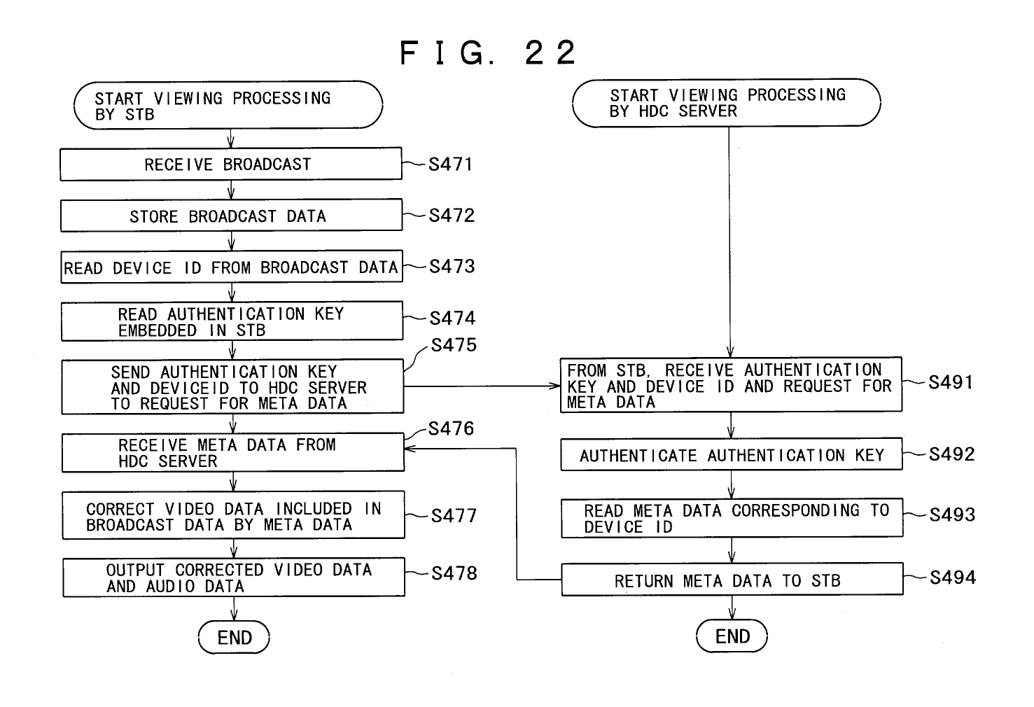

The following describes viewing processing with reference to the flowchart shown in FIG. 22.

In step S471, the broadcast receiving block 513 of the STB 52-2 receives a broadcast via the antenna 514. In step S472, the CPU 501 of the STB 52-2 stores the received broadcast data in the storage block 511. In step S473, the CPU 501 of the STB 52-2 reads the device IDs of the omnidirectional camera 31-2 and the VTR 32-2 from the broadcast data stored in the storage block 511. In step S474, the CPU 501 of the STB 52-2 reads the authentication key of the STB 52-2 from the ROM 502.

In step S475, the CPU 501 of the STB 52-2 sends, from the communication block 510, the authentication key and the device ID to the HDC server 35 via the network 10 to request for the meta data that correspond to the device ID.

In step S491, the CPU 301 of the HDC server 35 receives the authentication key and the device ID and the meta data transmission request from the STB 52-2 through the communication block 310. In step S492, the CPU 301 determines whether or not the authentication key received in step S491 matches the authentication key stored in the storage block 309 of the HDC server 35. If a match is found, the CPU 301 authenticates the received authentication key, upon which the procedure goes to step S493. If there is no match between the authentication key received in step S491 and the authentication key stored in the storage block 309 of the HDC server 35, then the CPU 301 of the HDC server 35 notifies, through the communication block 310, the STB 52-2 of that the meta data cannot be transmitted.

In step S493, on the basis of the ID device received in step S491, the CPU 301 of the HDC server 35 searches the, storage block 309 for the same device ID and read the meta data related with this device ID from the storage block 309. In step S494, the CPU 301 of the HDC server 35 sends the meta data read in step S493 to the STB 52-2 through the network 10 from the communication block 310.

In step S476, the CPU 501 of the STB 52-2 receives the meta data from the HDC server 35 through the communication block 510. In step S477, the CPU 501 of the STB 52-2 corrects the video data included in the broadcast data stored in the storage block 511 in step S472 by the meta data received in step S476. In step S478, the CPU 501 of the STB 52-2 outputs the video data corrected in step S 477 and the audio data included in the broadcast data to the television receiver 14 from the output block 509 for display thereon. By the above-mentioned processing, the user can view the corrected video on the television receiver 14.

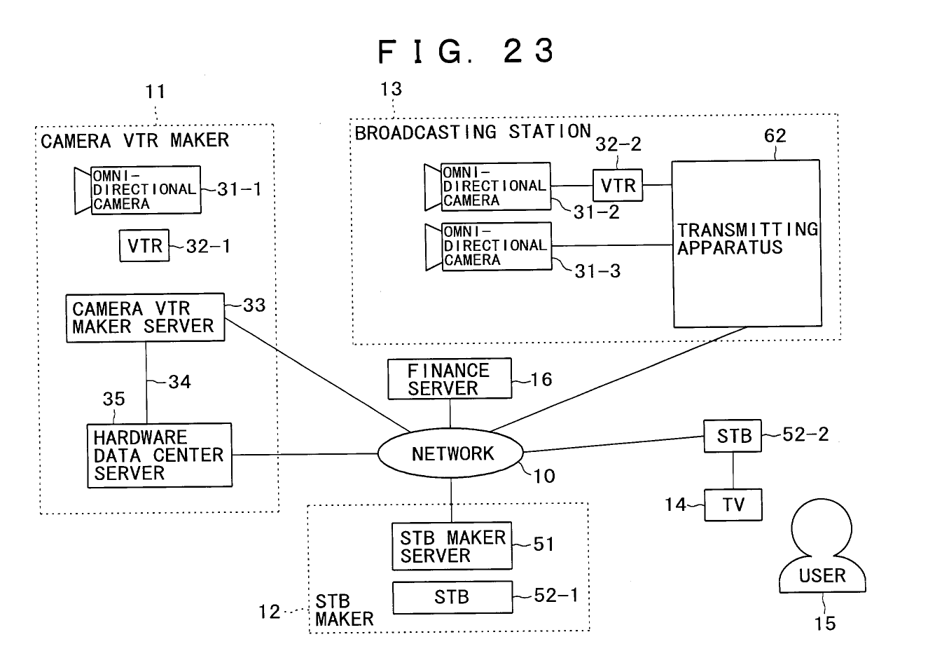

Referring to FIG. 23, there is shown a configuration of a service providing system according to the invention which is different from the service providing systems shown in FIGS. 1 and 19. In FIG. 23, the transmitting apparatus 62 shown in FIGS. 1 and 19 is connected to the network 10. The transmitting apparatus 62 supplies broadcast data such as programs to the STB 52 via the network 10. The STB 52 receives the a program broadcast at its communication block 510 via the network 10 without using the antenna 514 and the broadcast receiving block 513 unlike the service providing system shown in FIG. 19.

The other parts of the configuration are the same as those of the service providing system shown in FIG. 19, so that their description will be skipped.

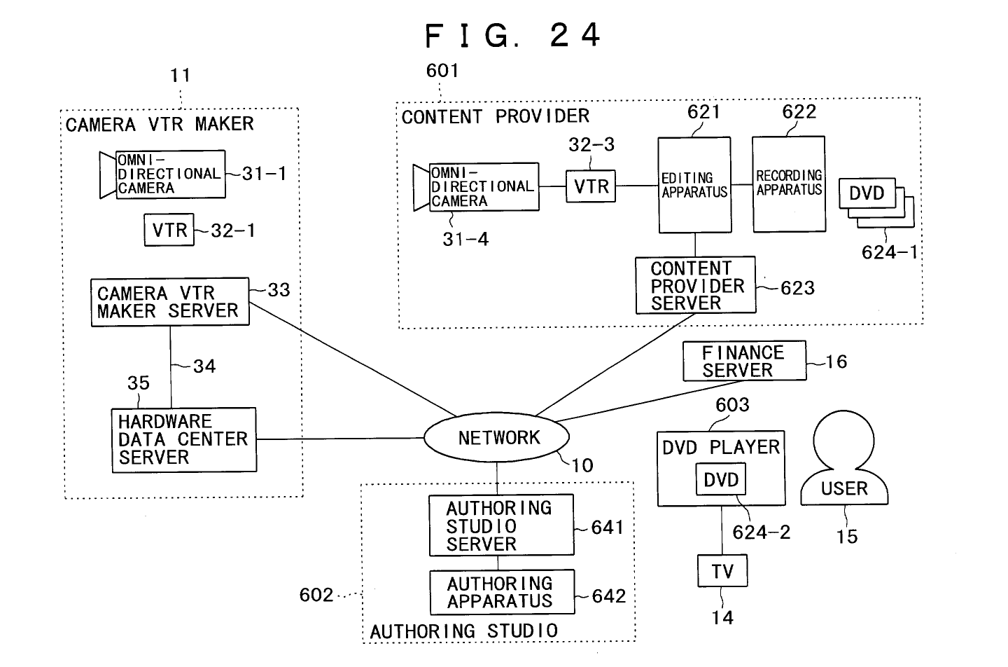

It should be noted here that the present invention may be applied to fields other than broadcasting. The following describes, with reference to FIG. 24, an example in which a service providing system practiced as one embodiment of the present invention is applied to a field other than broadcasting.

Referring to FIG. 24, the configuration of a camera VTR maker 11 is the same as those of the camera VTR makers 11 shown in FIGS. 1, 9, and 23. In addition, a finance server 16 is connected to a network 10 as with shown in FIGS. 1, 9, and 23.

As shown in FIG. 24, a content provider server 623 of a content provider 601 for creating movies, dramas and other content is connected to the network 10. In addition, an authoring studio server 641 of an authoring studio 602 running the business of correcting the video data taken by a content provider 601 by predetermined meta data is connected to the network 10.

In addition to the content provider server 623, the content provider 601 has an omnidirectional camera 31-4 and a VTR 32-3 purchased from the camera VTR maker 11. Further, the content provider 601 has an editing apparatus 621 for editing the video and audio data recorded to the VTR 32-3 and a recording apparatus 622 for recording, to a DVD (Digital Versatile Disc) 624-1, the data edited by the editing apparatus 621 into a completed work (hereafter also referred to as work data). It should be noted that, in FIG. 24, the recording apparatus 622 records the work data to the DVD 624-1; it will be apparent that any other recording media may be used for the recording apparatus 622 to record the work data.

In addition to the authoring studio server 641, the authoring studio 602 has an authoring apparatus 642 for correcting the video data taken by the omnidirectional camera 31 for example by predetermined meta data.

The user 15 may purchase the DVD 624 made by the content provider 601, reproduce the purchased DVD 624-2 on his/her DVD player 603, and display the content on a television receiver 14 for viewing. It should be noted that, in FIG. 24, the DVD player 603 is used; it will be apparent that any other reproducing apparatuses may be used for the reproduction of the work data as long as they are compatible with the type of recording media on which the work data are recorded by the content provider 601.

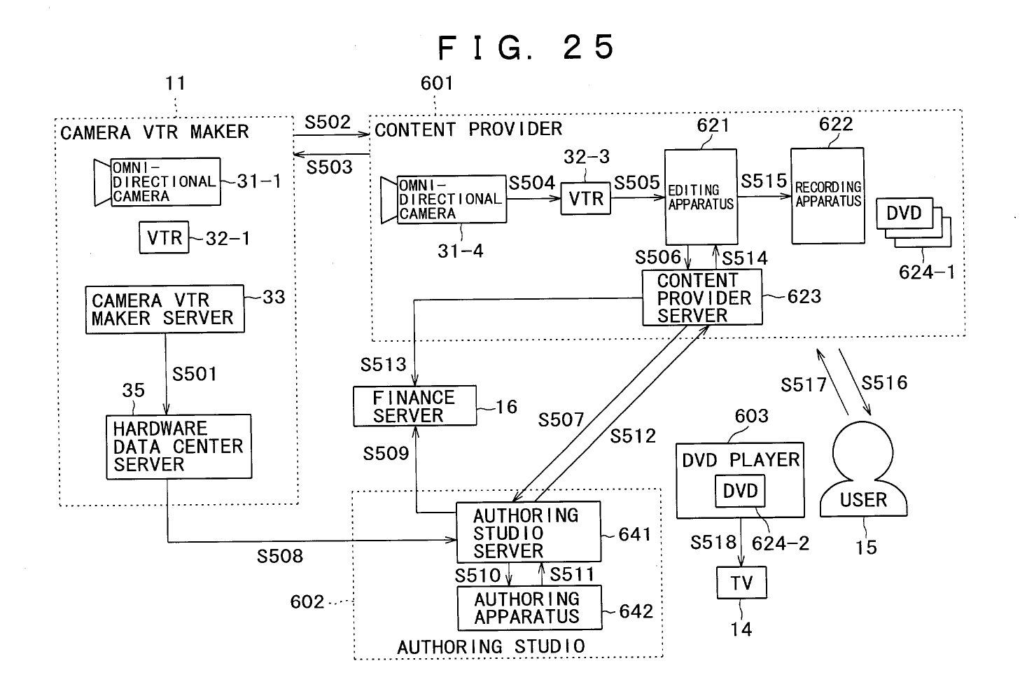

The following describes the overview of the service providing system shown in FIG. 24 with reference to FIG. 25.

In step S501 shown in FIG. 25, the camera VTR maker server 33 records the device IDs to the recording media in an omnidirectional camera 31-1 and a VTR 32-1 manufactured by the camera VTR maker 11 and requests an HDC server 35 to store the meta data inputted by the manufacturer of the omnidirectional camera 31 for example by relating the meta data with these device IDs. In response to this request by the camera VTR maker server 33, the HDC server 35 stores the received device IDs and meta data in a related manner. In addition, the HDC server 35 issues authentication keys and stores them as related with the device IDs and the meta data.

In step S502 shown in FIG. 25, the camera VTR maker 11 delivers the omnidirectional camera 31 and the VTR 32 to the content provider 601. In step S503, the content provider 601 pays the cost for the omnidirectional camera 31 and the VTR 32 to the camera VTR maker 11.

In step S504, the content provider 601 executes predetermined imaging processing by use of the purchased omnidirectional camera 31-4, thereby recording the captured video and audio data to a predetermined recording medium by the VTR 32-3. It should be noted that the device ID of the omnidirectional camera 31-4 and the device ID of the VTR 32-3 are also recorded to the recording medium along with the captured video and audio data.

In step S505, the VTR 32-2 sends the video data and audio data recorded in step S504 and the device IDs to the editing apparatus 621. The editing apparatus 621 stores the video and audio data and device IDs received from the VTR 32-3 into its incorporated hard disk. In step S506, the editing apparatus 621 sends the stored video data and device IDs to the content provider server 623. Receiving the video data and the device IDs from the editing apparatus 621, the content provider server 623 sends the received video data and device IDs to the authoring studio server 641 via the network 10 in step S507.

Receiving the video data and the device IDs from the content provider server 623, the authoring studio server 641 gets the meta data corresponding to the device IDs from the HDC server 35 in step S508. In step S509, authoring studio server 641 accesses a finance server 16 to remit the cost of a predetermined amount for the meta data to the account of the camera VTR maker 11.

In step S510, the authoring studio server 641 sends the video data received in step S507 and the meta data received from the HDC server 35 in step S508 to the authoring apparatus 642. Receiving the video data and the meta data from the authoring studio server 641, the authoring apparatus 642 corrects the video data by the meta data. In step S511, the authoring apparatus 642 sends the corrected video data to the authoring studio server 641.

In step S512, the authoring studio server 641 sends the corrected video data received from the authoring apparatus 642 to the content provider server 623 via the network 10.

Receiving the corrected video data from the authoring studio server 641, the content provider server 623 accesses the finance server 16 in step S513 to remit the cost of a predetermined amount for the video correction to the account of the authoring studio 602. In step S514, the content provider server 623 sends the corrected video data to the editing apparatus 621. The editing apparatus 621 performs further editing processing on the corrected video data received from the content provider server 623 to complete the work data. In step S515, the editing apparatus 621 sends the completed work data to the recording apparatus 622. The recording apparatus 622 stores the received work data into its incorporated hard disk and then records the work data to a plurality of DVDs 624-1. The DVDs 624-1 storing the work data are packaged in a predetermined case, which is sold as a product at CD stores for example.

In step S516, the user 15 purchases the DVD 624 as a product. In step S517, the user pays the cost for the purchased DVD 624. The DVD 624-2 purchased by the user 15 is reproduced by the DVD player 603. The reproduced video data are displayed on the television receiver 14. Thus, the processing shown in FIG. 25 is executed.

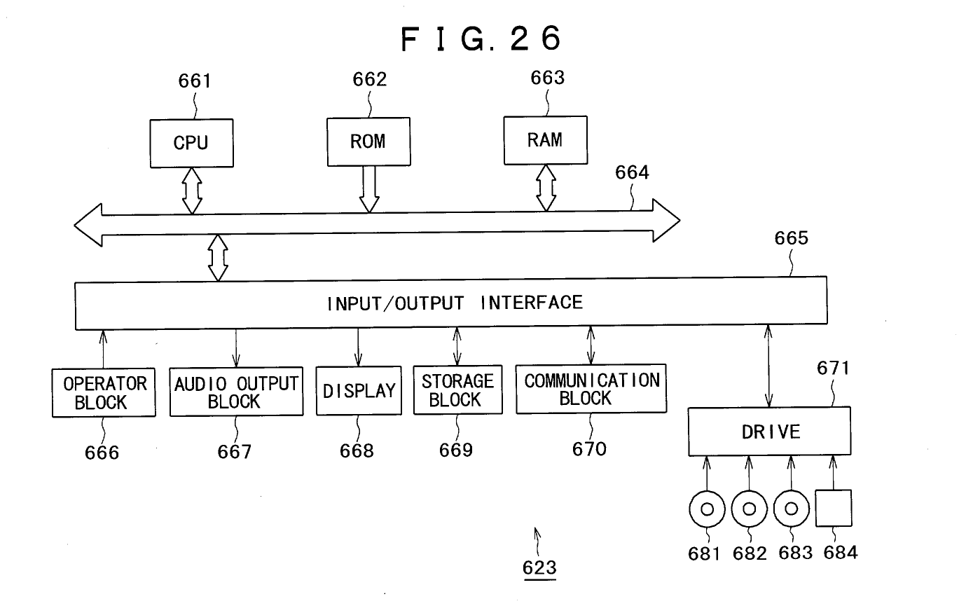

Referring to FIG. 26, there is shown an exemplary configuration of the content provider server 623. The components of the content provider server 623, a CPU 661 through a semiconductor memory 684 are basically the same in configuration as the CPU 251 through the semiconductor memory 284 that constitute the camera VTR maker server 33 shown in FIG. 5 and the corresponding components have the same corresponding functions. Therefore, the description of the corresponding components will be skipped.

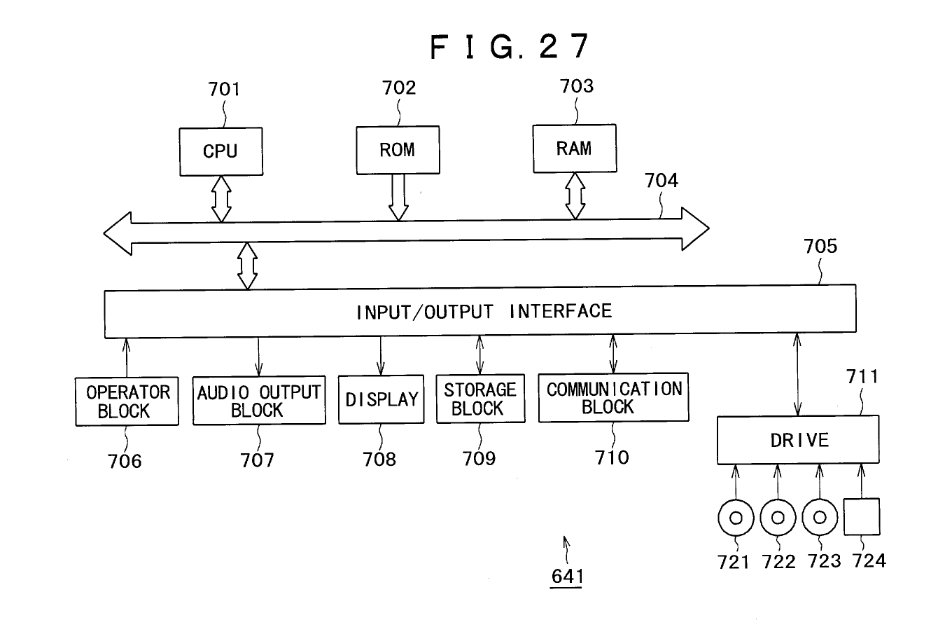

Referring to FIG. 27, there is shown an exemplary configuration of the authoring studio server 641. The components of the authoring studio server 641, a CPU 701 through a semiconductor memory 724 are basically the same in configuration as the CPU 251 through the semiconductor memory 284 that constitute the camera VTR maker server 33 shown in FIG. 5 and the corresponding components have the same corresponding functions. Therefore, the description of the corresponding components will be skipped.

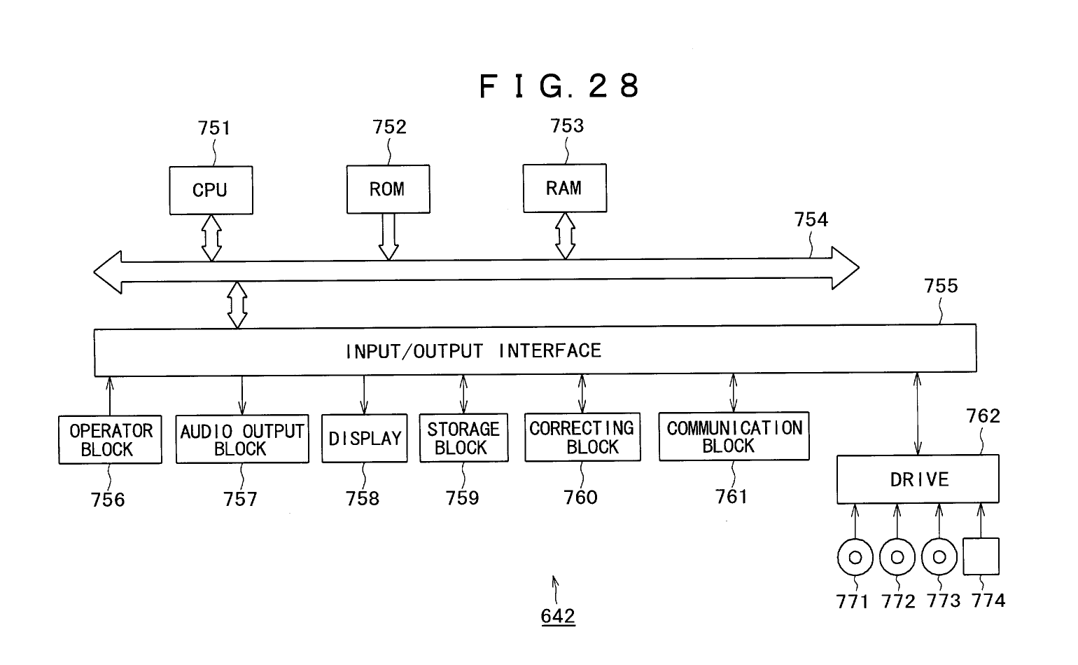

Referring to FIG. 28, there is shown an exemplary configuration of the authoring apparatus 642. As shown in FIG. 28, a CPU 751 executes various processing operations in accordance with programs stored in a ROM 752 or loaded from a storage block 759 to a RAM 753. The RAM 753 also suitably stores data that are necessary for the CPU 751 to execute various processing operations.

The CPU 751, the ROM 752, and the RAM 753 are interconnected via a bus 754. The bus 754 is also connected to an input/output interface 755.

The input/output interface 755 is connected to an operator block 756 composed of a plurality of buttons for accepting operator inputs by the user, an audio output block 757 for outputting audio, a display 758 composed of a CRT or an LCD for example, the storage block 759 composed of a hard disk for example, a correcting block 760 for correcting video data by meta data, and a communication block 761 composed of a modem and a terminal adaptor. The communication block 761 executes communication processing via the network 10 such as the Internet.

The input/output interface 755 is also connected to a drive 762 as required, on which a magnetic disk 771, an optical disk 772, a magneto-optical disk 773, or a semiconductor memory 774 is loaded as required. Computer programs are read from these recording media and are installed in the storage block 759 as required.

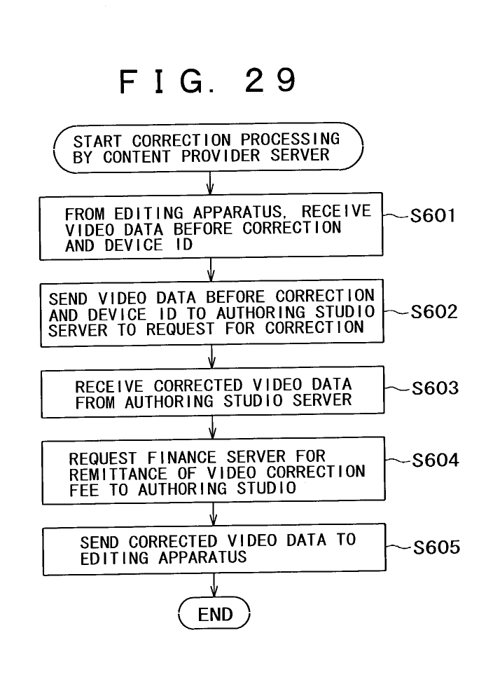

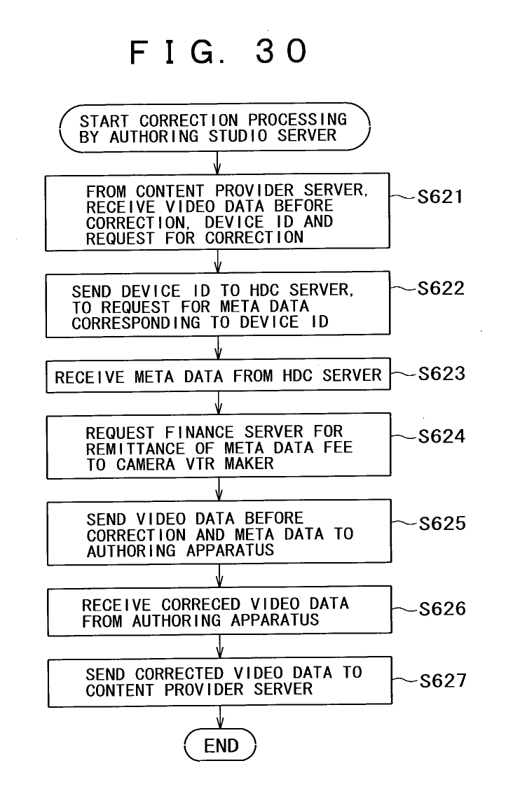

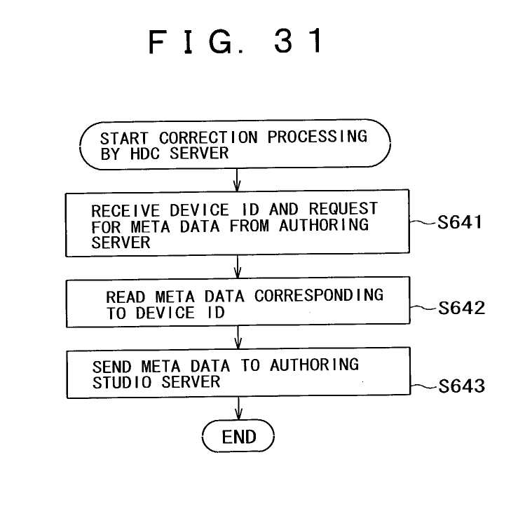

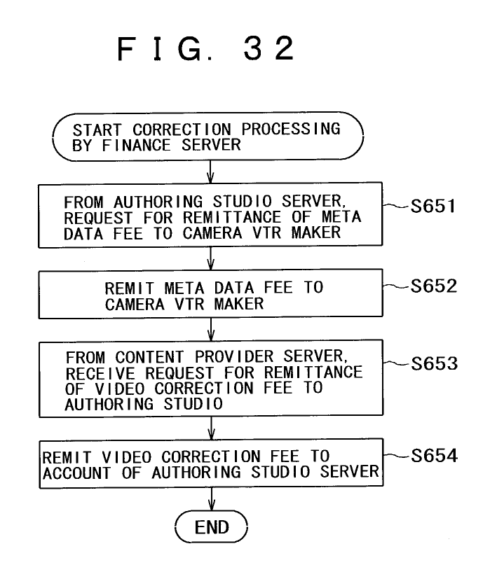

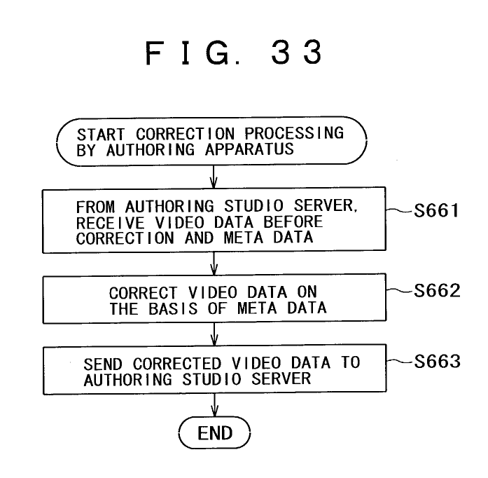

The following describes the correction processing by the service providing system shown in FIG. 24 with reference to the flowcharts shown in FIGS. 29 through 33. It should be noted that FIG. 29 shows the processing by the content provider server 623, FIG. 30 shows the processing by the authoring studio server 641, FIG. 31 shows the processing by the HDC server 35, FIG. 32 shows the processing by the finance server 16, and FIG. 33 shows the processing by the authoring apparatus 642.

In step S601 shown in FIG. 29, the CPU 661 of the content provider server 623 receives the video data before correction and the device ID from the editing apparatus 621 through the communication block 670. In step S602, the CPU 661 of the content provider server 623 sends, from the communication block 670, the video data before correction and the device ID received in step S601 to the authoring studio server 641 via the network 10 to request for the correction of the video data.

In step S621 shown in FIG. 30, the CPU 701 of the authoring studio server 641 receives, through the communication block 710, the video data before correction, the device ID, and the video data correcting request supplied from the content provider server 623 via the network 10 in step S602. The CPU 701 of the authoring studio server 641 stores the received video data before correction and device ID into the storage block 709.

In step S622, the CPU 701 of the authoring studio server 641 sends, through the communication block 710, the device ID received in step S621 to the HDC server 35 via the network 10 to request for the meta data that correspond to the device ID.

In step S641 shown in FIG. 31, the CPU 301 of the HDC server 35 receives, through the communication block 310, the device ID and the meta data transmission request supplied from the authoring studio server 641 via the network 10 in step S622.

In step S642, on the basis of the device ID received in step S641, the CPU 301 of the HDC server 35 searches the storage block 309 for the same device ID and, if the same device TD is found, reads the meta data from the storage block 309 which are stored as related to the detected device ID.

In step S643, the CPU 301 of the HDC server 35 sends the meta data read in step S642 to the authoring studio server 641 via the network 10 through the communication block 310.

In step S643, the authoring studio server 641 receives the meta data supplied from the HDC server 35 in step S623 shown in FIG. 30 via the network 10 and stores the received meta data into the storage block 709. In step S624, the CPU 701 of the authoring studio server 641 accesses the finance server 16 from the communication block 710 via the network 10 to request for remitting the charge of a predetermined amount for the meta data to the account of the camera VTR maker 11.

In step S651 shown in FIG. 32, the finance server 16 receives the request transmitted by the authoring studio server 641 in step S624 via the network 10 for remitting the charge of a predetermined amount for the meta data to the account of the camera VTR maker 11. In step S652, the finance server 16 executes the processing of remitting the charge of a predetermined amount for the meta data to the account of the camera VTR maker 11. It should be noted that, at this moment, the same amount as remitted to the account of the camera VTR maker 11 is drawn from the account of the authoring studio 602.

In step S625 shown in FIG. 30, the CPU 701 of the authoring studio server 641 reads the video data before correction and the meta data from the storage block 709 and send these data to the authoring apparatus 642 through the communication block 710.

In step S661 shown in FIG. 33, the CPU 751 of the authoring apparatus 642 receives, through the communication block 761, the video data before correction and the meta data transmitted by the authoring studio server 641 in step S625. In step S662, the CPU 751 supplies the received data to the correcting block 760. The correcting block 760 corrects the received video data by the received meta data.

After the correction of the video data, the CPU 751 of the authoring apparatus 642 sends the corrected video supplied from the correcting block 760 to the authoring studio server 641 through the communication block 761 in step S663.

In step S626 shown in FIG. 30, the CPU 701 of the authoring studio server 641 receives, through the communication block 710, the corrected video data supplied from the authoring apparatus 642 in step S663. In step S627, the CPU 701 of the authoring studio server 641 sends the corrected video data received in step S626 to the content provider server 623 through the communication block 710 via the network 10.

In step S603 shown in FIG. 29, the CPU 661 of the content provider server 623 receives, through the communication block 670, the corrected video data transmitted from the authoring studio server 641 in step S627.

In step S604, the CPU 661 of the content provider server 623 accesses the finance server 16 through the communication block 670 via the network 10 to request for the remittance of the charge of a predetermined amount for the video correction to the account of the authoring studio 602.

In step S653 shown in FIG. 32, the finance server 16 receives the request transmitted from the content provider server 623 in step S604 via the network 10 for the remittance of the charge of a predetermined amount for the video correction to the account of the authoring studio 602. In step S654, the finance server 16 executes the processing of remitting the charge of a predetermined amount for the video correction to the account of the authoring studio 602. It should be noted that, at this moment, the same amount of money as remitted to the account of the authoring studio 602 is drawn from the account of the content provider 601.

In step S605 shown in FIG. 29, the CPU 661 of the content provider server 623 sends the corrected video data received in step S603 to the editing apparatus 621 through the communication block 670. The editing apparatus 621 edits the corrected video data received from the content provider server 623 into work data.

Thus, the correction processing by the service providing system shown in FIG. 24 is performed.

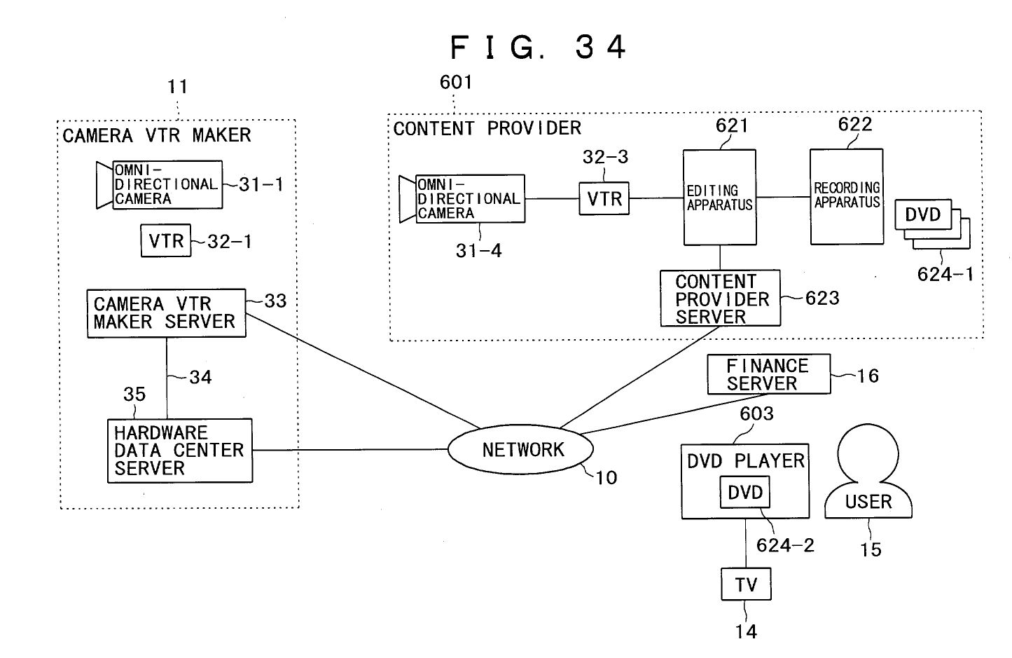

It should be noted that the content provider 601 and the authoring studio 602 shown in FIG. 24 may be integrated into one business entity (for example, a broadcasting station). The following describes an exemplary configuration of a service providing system in which the content provider 601 and the authoring studio 602 are integrated into one business entity, with reference to FIG. 34. In FIG. 34, the processing to be executed by the authoring studio server 641 shown in FIG. 24 is partially carried out by the content provider server 623 shown in FIG. 34 and the processing to be executed by the authoring apparatus 642 shown in FIG. 24 is carried out by the editing apparatus 621 shown in FIG. 34.

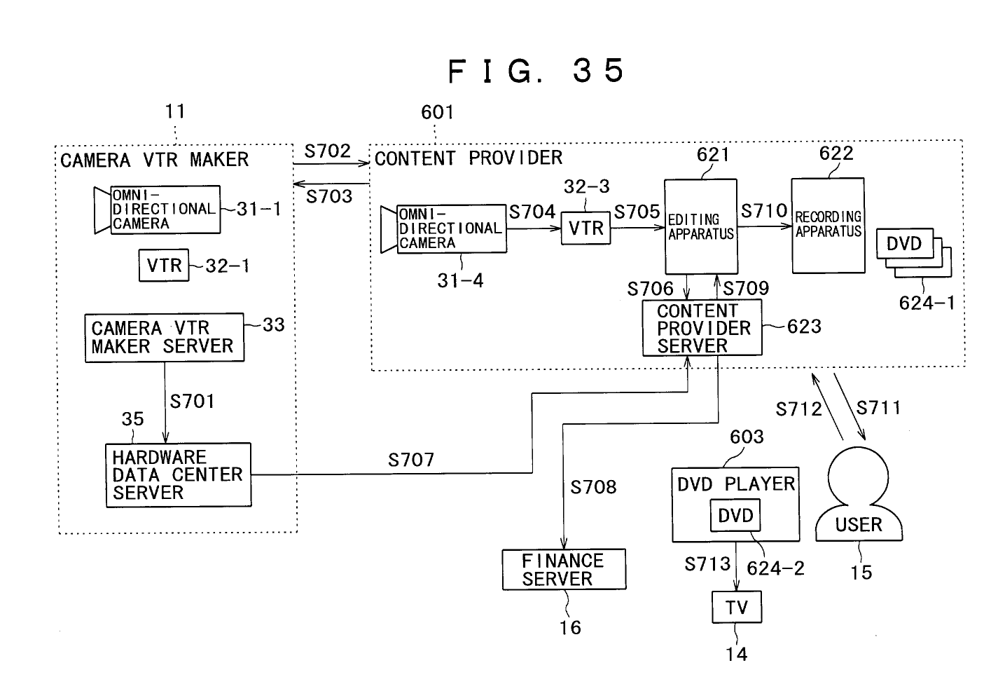

With reference to FIG. 35, the following describes the overview of the service providing system shown in FIG. 34.

In step S701, a camera VTR maker server 33 records device IDs to recording media in a omnidirectional camera 31-1 and a VTR 32-1 manufactured by a camera VTR maker 11 and requests a HDC server 35 to store meta data inputted by the manufacturer of omnidirectional cameras 31 for example by relating the meta data with the device TDs. In response to the request from the camera VTR maker server 33, the HDC server 35 stores the received device IDs and meta data in a related manner. In addition, the HDC server 35 issues authentication keys and stores them as related with the device IDs and the meta data.

In step S702 shown in FIG. 25, the camera VTR maker 11 delivers the omnidirectional camera 31 and the VTR 32 to a content provider 601. In step S703, the content provider 601 pays the cost for the omnidirectional camera 31 and the VTR 32 to the camera VTR maker 11.

In step S704, the content provider 601 executes predetermined imaging processing by use of the omnidirectional camera 31-4 purchased from the camera VTR maker 11 and records the captured video and audio data to a predetermined recording medium through the VTR 32-3. It should be noted that, at time moment, the device ID of the omnidirectional camera 31-4 and the device ID of the VTR 32-3 are recorded to the recording medium along with the captured video and audio data.

In step S705, the VTR 32-3 sends the video and audio data and the device IDs recorded in step S704 to an editing apparatus 621. The editing apparatus 621 stores the video and audio data and device IDs received from the VTR 32-3 to its incorporated hard disk. In step S706, the editing apparatus 621 sends the device ID to the content provider server 623.

Receiving the device ID from the editing apparatus 621, the content provider server 623 gets the meta data corresponding to the device ID from the HDC server 35 via the network 10 in step S707. In step S708, the content provider server 623 accesses a finance server 16 to remit the charge of a predetermined amount for the meta data to the account of the camera VTR maker 11.

In step S709, the content provider server 623 sends the meta data received from the HDC server 35 in step S707 to the editing apparatus 621. Receiving the meta data from the content provider server 623, the editing apparatus 621 corrects the video data by the meta data. Then, the editing apparatus 621 edits the corrected video data into work data and sends the completed work data to a recording apparatus 622 in step S710. The recording apparatus 622 stores the received work data into its incorporated hard disk and then records the stored work data to a plurality of DVDs 624-1. The DVDs 624-1 storing the work data are packaged in a predetermined case, which is sold at CD stores for example as a product.

In step S711, a user 15 purchases the DVD 624 as a product and pays the cost for this product in step S712. The DVD 624-2 purchased by the user 15 is reproduced on a DVD player 603 in step S713. The reproduced video is displayed on a television receiver 14.

The overview of the service providing system shown in FIG. 35 is as described above. Thus, the service providing systems according to the invention may be configured as described above. It should be noted that the content provider 601 may distribute the work data not only with the recording media such as DVDs but also by broadcasting or via the network 10 for example.

As described and according to the invention, the service providing systems according to the invention allow the correction of video data in accordance with the characteristics unique to imaging apparatuses such as the omnidirectional camera 31, so that the user can view the video that is more real than that achieved by related-art technologies.

In addition, the service providing systems according to the invention allow the manufacturer and seller of professional-use apparatuses such as the omnidirectional camera 31 to increase profits by selling meta data and authentication keys after selling the apparatuses themselves.

The description made so far uses the omnidirectional camera 31 as one example. It does not necessarily denote that the present invention is applicable only to the omnidirectional camera 31. That is, the present invention is also applicable to any other models of imaging apparatuses.

The above-mentioned sequences of processing may be executed by not only hardware but also software. To have software execute the above-mentioned sequences of processing, the programs constituting the software are installed, from networks or recording media, into a computer assembled in a dedicated hardware unit (for example, CPU 201, 251, 301, 351, 401, 451, 501, 551, 661, 701, or 751) or a general-purpose personal computer for example capable of executing various functions by installing various programs.

The program storage media for storing programs which are installed in a computer and made executable by it may be constituted by package media including a magnetic disk 221, 281, 321, 371, 421, 471, 521, 571, 681, 721 or 771 (including flexible disk), an optical disk 222, 282, 322, 372, 422, 472, 522, 572, 682, 722 or 772 (including DC-ROM (Compact Disk Read Only Memory) and DVD), a magneto-optical disk 223, 283, 323, 373, 423, 473, 523, 573, 683, 723 or 773, or a semiconductor memory 224, 284, 324, 374, 424, 474, 524, 574, 684, 724 or 774. As required, programs are stored in program storage media by use of wired or wireless communication medium such as a local area network, the Internet, or digital satellite broadcasting through a rooter and a modem for example.

It should be noted that the steps describing each program recorded on the recording media may include herein not only the processing which is executed in a time-dependent manner in accordance with a predetermined sequence but also the processing which is executed in a parallel or discrete manner.

It should also be noted that the system as used herein denotes an entire entity configured by a plurality of component apparatuses.

As described above, according to the present invention, video data may be corrected.

In addition, according to the present invention, video data may be corrected in accordance with the characteristics unique to each imaging equipment unit. Further, according to the present invention, the manufacturer and seller of professional-use apparatuses may increase profits by selling meta data and authentication keys after selling the apparatuses themselves.

While the preferred embodiments of the present invention have been described using specific terms, such description is for illustrative purposes only, and it is to be understood that changes and variations may be made without departing from the spirit or scope of the appended claims.

What is claimed is:

1. In a service providing system configured by a first information processing apparatus for managing correction information unique to each model of imaging apparatus for correcting video data taken by said imaging apparatus, a second information processing apparatus for multiplexing said correction information with said video data and broadcasting the multiplexed video data as a broadcast, and a third information processing apparatus for receiving said broadcast,
said first information processing apparatus comprising:
storage means for storing said correction information; and
transmitting means for transmitting said correction information from said storage means to said second information processing apparatus,
said second information processing apparatus comprising:
first receiving means for receiving said correction information from said first information processing apparatus; and
broadcasting means for multiplexing said correction information with said video data captured by said imaging apparatus and broadcasting the multiplexed video data, and
said third information processing apparatus comprising:
second receiving means for receiving said multiplexed video data broadcast by said second information processing apparatus; and
correcting means for correcting said video data by said correction information multiplexed with said video data received by said second receiving means.

2. An information processing apparatus comprising:
storage means for storing correction information unique to each model of imaging apparatus for correcting video data captured by said imaging apparatus; and
transmitting means for transmitting said correction information from said storage means to first another information processing apparatus.

3. The information processing apparatus according to claim 2, further comprising:
first issuing means for issuing identification information for identifying said each model of imaging apparatus; and
recording means for recording said identification information issued by said first issuing means to said imaging apparatus.

4. The information processing apparatus according to claim 3, wherein said storage means stores said correction information and said identification information in a mutually related manner.

5. The information processing apparatus according to claim 3, further comprising:
second issuing means for issuing key information for permitting second another information processing apparatus which receives said video data from said first another information processing apparatus to correct said video data by said correction information.

6. The information processing apparatus according to claim 5, wherein said storage means stores said correction information, said identification information, and said key information in a mutually related manner.

7. The information processing apparatus according to claim 6, wherein said transmitting means transmits, to said first another information processing apparatus, said key information stored by said storage means in a mutually related manner with said correction information.

8. The information processing apparatus according to claim 2, further comprising:
receiving means for receiving a request by said first another information processing apparatus for transmitting said correction information;
wherein, if said request for the transmission of said correction information was received by said receiving means, said transmitting means transmits said correction information to said first another information processing apparatus.

9. An information processing method comprising the steps of:
storing correction information unique to each model of imaging apparatus for correcting video data taken by said imaging apparatus; and
transmitting said correction information stored by the storage step to another information processing apparatus.

10. A recording medium storing a computer-readable program comprising the steps of:
storage control for controlling storage of correction information unique to each model of imaging apparatus for correcting video data taken by said imaging apparatus; and
transmission control for controlling transmission of said correction information stored by the storage control step to another information processing apparatus.

11. A program for causing a computer to execute the steps of:
storage control for controlling storage of correction information unique to each model of imaging apparatus for correcting video data taken by said imaging apparatus; and
transmission control for controlling transmission of said correction information stored by the storage control step to another information processing apparatus.

12. An information processing apparatus comprising:
receiving means for receiving correction information unique to each model of imaging apparatus for correcting video data taken by said imaging apparatus from a first another information apparatus; and
broadcasting means for multiplexing said video data taken by said imaging apparatus with said correction information for broadcasting.

13. The information processing apparatus according to claim 12, further comprising:
requesting means for requesting said first another information processing apparatus for transmitting said correction information.

14. The information processing apparatus according to claim 12, further comprising:
storage means for storing said correction information received by said receiving means.

15. The information processing apparatus according to claim 12, wherein said receiving means receives, along with said correction information, key information for permitting a second another information processing apparatus which receives said video data to correct said received video data by said correction information.

16. The information processing apparatus according to claim 15, further comprising:
storage means for storing said correction information and said key information received by said receiving means.

17. The information processing apparatus according to claim 15, wherein said broadcasting means multiplexes said video data with said correction information and said key information for broadcasting.

18. The information processing apparatus according to claim 12, further comprising:
recording means for recording said video data taken by said imaging apparatus.

19. The information processing apparatus according to claim 18, wherein said recording means records, along with said video data, identification information for identifying said imaging apparatus.

20. The information processing apparatus according to claim 18, wherein said recording means records audio data along with said video data.

21. An information processing method comprising the steps of:
receiving correction information unique to each model of imaging apparatus for correcting video data taken by said imaging apparatus from another information apparatus; and
multiplexing said video data taken by said imaging apparatus with said correction information for broadcasting.

22. A recording medium storing a computer-readable program comprising the steps of:
reception control for receiving correction information unique to each model of imaging apparatus for correcting video data taken by said imaging apparatus from another information apparatus; and
broadcasting control for multiplexing said video data taken by said imaging apparatus with said correction information for broadcasting.

23. A program for causing a computer to execute the steps of:
reception control for receiving correction information unique to each model of imaging apparatus for correcting video data taken by said imaging apparatus from another information apparatus; and
broadcasting control for multiplexing said video data taken by said imaging apparatus with said correction information for broadcasting.

24. An information processing apparatus for receiving a broadcast in which correction information unique to each model of imaging apparatus for correcting video data taken by said imaging apparatus is multiplexed with said video data, comprising:
receiving means for receiving said video data broadcast by a first another information processing apparatus; and
correcting means for correcting said video data by said correction information multiplexed with said video data received by said receiving means.

25. The information processing apparatus according to claim 24, further comprising:
storage means for storing key information for permitting the correction of said video data by said correction information;
acquiring means for acquiring said key information multiplexed with said video data received by said receiving means; and
decision means for deciding whether or not said video data may be corrected by comparing said key information stored in said storage means with said key information acquired by said acquiring means;
wherein, if said video data are found correctable by said decision means, said correcting means corrects said video data.

26. An information processing method for an information processing apparatus for receiving a broadcast in which correction information unique to each model of imaging apparatus for correcting video data taken by said imaging apparatus is multiplexed with said video data, comprising the steps of:
receiving said video data broadcast by another information processing apparatus; and
correcting said video data by said correction information multiplexed with said video data received by said receiving step.

27. A recording medium storing a computer-readable program for an information processing apparatus for receiving a broadcast in which correction information unique to each model of imaging apparatus for correcting video data taken by said imaging apparatus is multiplexed with said video data, comprising the steps of:
reception control for receiving said video data broadcast by another information processing apparatus; and
correction control for correcting said video data by said correction information multiplexed with said video data received by said reception control step.

28. A program for causing a computer for controlling an information processing apparatus for receiving a broadcast in which correction information unique to each model of imaging apparatus for correcting video data taken by said imaging apparatus is multiplexed with said video data to execute the steps of:
reception control for receiving said video data broadcast by another information processing apparatus; and
correction control for correcting said video data by said correction information multiplexed with said video data received by said reception control step.

29. In a service providing system configured by a first information processing apparatus for managing correction information unique to each model of imaging apparatus for correcting video data taken by said imaging apparatus, a second information processing apparatus multiplexing identification information for identifying said imaging apparatus with said video data and broadcasting the multiplexed video data as a broadcast, and a third information processing apparatus for receiving said broadcast,
said first information processing apparatus comprising:
storage means for storing said correction information as related with said identification information;
first receiving means for receiving a request for the transmission of said correction information corresponding to said identification information from said third information processing apparatus; and
transmitting means for transmitting said correction information stored by said storage means as related with said identification information to said third information processing apparatus if said request is received by said first receiving means,
said second information processing apparatus comprising:
broadcasting means for multiplexing said identification information with said video data taken by said imaging apparatus for broadcasting, and
said third information processing apparatus comprising:
second receiving means for receiving said video data broadcast by said second information processing apparatus;
reading means for reading said identification information multiplexed with said video data received by said second receiving means;
requesting means for requesting said first information processing apparatus for said correction information corresponding to said identification information read by said reading means;
third receiving means for receiving said correction information from said first information processing apparatus; and
correcting means for correcting said video data by said correction information received by said third receiving means.

30. An information processing apparatus comprising:
storage means for storing correction information unique to each model of imaging apparatus for correcting video data taken by said imaging apparatus, as related with identification information for identifying said imaging apparatus;
receiving means for receiving a request from another information processing apparatus for the transmission of said correction information corresponding to said identification information; and
transmitting means for transmitting said correction information stored by said storage means as related with said identification information to said another information processing apparatus if said request is received by said receiving means.

31. The information processing apparatus according to claim 30, wherein said storage means stores key information for permitting said another information processing apparatus to correct said video data and said receiving means receives said key information along with said request.

32. The information processing apparatus according to claim 31, further comprising:
decision means for deciding whether or not the correction of said video data is permitted by said key information received by said receiving means;
said transmitting means transmitting said correction information to said another information processing apparatus if the correction of said video data is found permitted.

33. An information processing method comprising the steps of:
storing correction information unique to each model of imaging apparatus for correcting video data taken by said imaging apparatus, as related with identification information for identifying said imaging apparatus;
receiving a request from another information processing apparatus for the transmission of said correction information corresponding to said identification information; and
transmitting said correction information stored by said storage step as related with said identification information to said another information processing apparatus if said request is received by said receiving step.

34. A recording medium storing a computer-readable program comprising the steps of:
storage control for storing correction information unique to each model of imaging apparatus for correcting video data taken by said imaging apparatus, as related with identification information for identifying said imaging apparatus;
reception control for receiving a request from another information processing apparatus for the transmission of said correction information corresponding to said identification information; and
transmission control for transmitting said correction information stored by said storage control step as related with said identification information to said another information processing apparatus if said request is received by said reception control step.

35. A program for causing a computer to execute the steps of:
storage control for storing correction information unique to each model of imaging apparatus for correcting video data taken by said imaging apparatus, as related with identification information for identifying said imaging apparatus;
reception control for receiving a request from another information processing apparatus for the transmission of said correction information corresponding to said identification information; and
transmission control for transmitting said correction information stored by said storage control step as related with said identification information to said another information processing apparatus if said request is received by said reception control step.

36. An information processing apparatus comprising:
broadcasting means for multiplexing video data taken by an imaging apparatus with identification information for identifying said imaging apparatus and broadcasting the resultant video data.

37. An information processing method comprising the step of:
multiplexing video data taken by an imaging apparatus with identification information for identifying said imaging apparatus and broadcasting the resultant video data.

38. A recording medium storing a computer-readable program comprising the step of:
multiplexing video data taken by an imaging apparatus with identification information for identifying said imaging apparatus and broadcasting the resultant video data.

39. A program for causing a computer to execute the step of:
multiplexing video data taken by an imaging apparatus with identification information for identifying said imaging apparatus and broadcasting the resultant video data.

40. An information processing apparatus comprising:
first receiving means for receiving video data broadcast by a first another information processing apparatus;
reading means for reading identification information for identifying an imaging apparatus multiplexed with said video data received by said first receiving means;
requesting means for requesting a second another information processing apparatus for correction information corresponding to said identification information read by said reading means for correcting said video data;
second receiving means for receiving said correction information from said second information processing apparatus; and
correcting means for correcting said video data by said correction information received by said second receiving means.

41. The information processing apparatus according to claim 40, further comprising:
storage means for storing key information for said second another information processing apparatus to decide whether or not said second another information processing apparatus may provide said correction information to said information processing apparatus;
wherein said requesting means transmits said key information stored by said storage means to said second information processing apparatus to request for said correction information.

42. An information processing method comprising the steps of:
receiving video data broadcast by a first another information processing apparatus;
reading identification information for identifying an imaging apparatus multiplexed with said video data received by said first receiving step;
requesting a second another information processing apparatus for correction information corresponding to said identification information read by said reading step for correcting said video data;
receiving said correction information from said second another information processing apparatus; and
correcting said video data by said correction information received by said second receiving step.

43. A recording medium storing a computer-readable program comprising the steps of:
reception control for receiving video data broadcast by a first another information processing apparatus;
read control for reading identification information for identifying an imaging apparatus multiplexed with said video data received by said first reception control step;
request control for requesting a second another information processing apparatus for correction information corresponding to said identification information read by said read control step for correcting said video data;
reception control for receiving said correction information from said second information processing apparatus; and
correction control for correcting said video data by said correction information received by said second reception control step.

44. A program for causing a computer to execute the steps of:
reception control for receiving video data broadcast by a first another information processing apparatus;
read control for reading identification information for identifying an imaging apparatus multiplexed with said video data received by said first reception control step;
request control for requesting a second another information processing apparatus for correction information corresponding to said identification information read by said read control step for correcting said video data;
reception control for receiving said correction information from said second another information processing apparatus; and
correction control for correcting said video data by said correction information received by said second reception control step.

45. In a service providing system configured by a first information processing apparatus for managing correction information unique to each model of imaging apparatus for correcting video data taken by said imaging apparatus, a second information processing apparatus for taking video data with said imaging apparatus to create content, and a third information processing apparatus for correcting said video data taken by said imaging apparatus,
said first information processing apparatus comprising:
recording means for recording identification information for identifying said imaging apparatus to said imaging apparatus;
storage means for storing said correction information as related with said identification information;
first receiving means for receiving a request for the transmission of said correction information corresponding to said identification information from said third information processing apparatus; and
first transmitting means for transmitting said correction information stored by said storage means as related with said identification information to said third information processing apparatus if said request is received by said first receiving means,
said second information processing apparatus comprising:
first requesting means for transmitting said video data taken by said imaging apparatus and said identification information to said third information processing apparatus to request for the correction of said video data; and
second receiving means for receiving the corrected video data from said third information processing apparatus, and
said third information processing apparatus comprising:
third receiving means for receiving said video data, said identification information, and said request for the correction of said video data from said second information processing apparatus;
second requesting means for requesting said first information processing apparatus for said correction information corresponding to said identification information received by said third receiving means;
fourth receiving means for receiving said correction information from said first information processing apparatus;
correcting means for correcting said video data by said correction information received by said fourth receiving means; and
second transmitting means for transmitting said video data corrected by said correcting means to second information processing apparatus.

46. An information processing apparatus comprising:
recording means for recording identification information for identifying an imaging apparatus to said imaging apparatus;
storage means for storing correction information unique to each model of said imaging apparatus for correcting video data taken by said imaging apparatus as related with said identification information;
receiving means for receiving from another information processing apparatus a request for the transmission of said correction information corresponding to said identification information; and
transmitting means for transmitting said correction information stored by said storage means as related with said identification information to said another information processing apparatus if said request is received by said receiving means.

47. An information processing method comprising the steps of:
recording identification information for identifying an imaging apparatus to said imaging apparatus;
storing correction information unique to each model of said imaging apparatus for correcting video data taken by said imaging apparatus as related with said identification information;
receiving from another information processing apparatus a request for the transmission of said correction information corresponding to said identification information; and
transmitting said correction information stored by said storage step as related with said identification information to said another information processing apparatus if said request is received by said receiving step.

48. A recording medium storing a computer-readable program comprising the steps of:
recording control for recording identification information for identifying an imaging apparatus to said imaging apparatus;
storage control for storing correction information unique to each model of said imaging apparatus for correcting video data taken by said imaging apparatus as related with said identification information;
reception control for receiving from another information processing apparatus a request for the transmission of said correction information corresponding to said identification information; and
transmission control for transmitting said correction information stored by said storage control step as related with said identification information to said another information processing apparatus if said request is received by said reception control step.

49. A program for causing a computer to execute the steps of:
recording control for recording identification information for identifying an imaging apparatus to said imaging apparatus;
storage control for storing correction information unique to each model of said imaging apparatus for correcting video data taken by said imaging apparatus as related with said identification information;
reception control for receiving from another information processing apparatus a request for the transmission of said correction information corresponding to said identification information; and
transmission control for transmitting said correction information stored by said storage control step as related with said identification information to said another information processing apparatus if said request is received by said reception control step.

50. An information processing apparatus for taking video data by an imaging apparatus to create content, comprising:
requesting means for requesting the transmission of said video data taken by said imaging apparatus and identification information for identifying said imaging apparatus to another information processing apparatus to request for the correction of said video data; and
receiving means for receiving the corrected video data from said another information processing apparatus.

51. An information processing method for information processing apparatus for taking video data by an imaging apparatus to create content, comprising the steps of:
requesting the transmission of said video data taken by said imaging apparatus and identification information for identifying said imaging apparatus to another information processing apparatus to request for the correction of said video data; and
receiving the corrected video data from said another information processing apparatus.

52. A recording medium storing a computer-readable program for an information processing apparatus for taking video data by an imaging apparatus to create content, comprising the steps of:
request control for requesting the transmission of said video data taken by said imaging apparatus and identification information for identifying said imaging apparatus to another information processing apparatus to request for the correction of said video data; and
reception control for receiving the corrected video data from said another information processing apparatus.

53. A program for causing a computer for an information processing apparatus for taking video data by an imaging apparatus to create content to execute the steps of:
request control for requesting the transmission of said video data taken by said imaging apparatus and identification information for identifying said imaging apparatus to another information processing apparatus to request for the correction of said video data; and
reception control for receiving the corrected video data from said another information processing apparatus.

54. An information processing apparatus comprising:
first receiving means for receiving video data taken by an imaging apparatus, identification information for identifying said imaging apparatus, and a request for the correction of said video data from a first another apparatus;
requesting means for requesting a second another information processing apparatus for correction information unique to each model of said imaging apparatus for correcting said video data taken by said imaging apparatus, said correction information corresponding to said identification information received by said first receiving means;
second receiving means for receiving said correction information from said second another information processing apparatus;
correcting means for correcting said video data by said correction information received by said second receiving means; and
transmitting means for transmitting said video data corrected by said correcting means to said first another information processing apparatus.

55. An information processing method comprising the steps of:
receiving video data taken by an imaging apparatus, identification information for identifying said imaging apparatus, and a request for the correction of said video data from a first another information processing apparatus;
requesting a second another information processing apparatus for correction information unique to each model of said imaging apparatus for correcting said video data taken by said imaging apparatus, said correction information corresponding to said identification information received by said first receiving step;
receiving said correction information from said second another information processing apparatus;
correcting said video data by said correction information received by said second receiving step; and
transmitting said video data corrected by said correcting step to said first another information processing apparatus.

56. A recording medium storing a computer-readable program comprising the steps of:
reception control for receiving video data taken by an imaging apparatus, identification information for identifying said imaging apparatus, and a request for the correction of said video data from a first another information processing apparatus;
request control for requesting a second another information processing apparatus for correction information unique to each model of said imaging apparatus for correcting said video data taken by said imaging apparatus, said correction information corresponding to said identification information received by said first reception control step;
reception control for receiving said correction information from said second another information processing apparatus;
correction control for correcting said video data by said correction information received by said second reception control step; and
transmission control for transmitting said video data corrected by said correction control step to said first another information processing apparatus.

57. A program for causing a computer to execute the steps of:
reception control for receiving video data taken by an imaging apparatus, identification information for identifying said imaging apparatus, and a request for the correction of said video data from a first another apparatus;
request control for requesting a second another information processing apparatus for correction information unique to each model of said imaging apparatus for correcting said video data taken by said imaging apparatus, said correction information corresponding to said identification information received by said first reception control step;
reception control for receiving said correction information from said second another information processing apparatus;
correction control for correcting said video data by said correction information received by said second reception control step; and
transmission control for transmitting said video data corrected by said correction control step to said first another information processing apparatus.
